(19) United States
(12) Patent Application Publication
(10) Pub. No.: US 2026/0135682 A1
(43) Pub. Date: May 14, 2026

(54) AVAILABILITY OF SIGNALS IN TIME DIVISION DUPLEX MODE OF OPERATION

(71) Applicant: QUALCOMM Incorporated, San Diego, CA (US)

(72) Inventors: Ayan SENGUPTA, Mountain View, CA (US); Alberto RICO ALVARINO, San Diego, CA (US)

(21) Appl. No.: 19/325,588

(22) Filed: Sep. 11, 2025

Related U.S. Application Data
(60) Provisional application No. 63/718,114, filed on Nov. 8, 2024.

(51) Int. Cl. H04L 5/14; H04L 5/00

(52) U.S. Cl. CPC H04L 5/14; H04L 5/0048

(57) ABSTRACT

Various aspects of the present disclosure generally relate to wireless communication. In some aspects, a user equipment (UE) may obtain an indication of a reference signal configuration associated with a time division duplex (TDD) mode of operation, wherein the reference signal configuration indicates at least one reference signal transmission pattern. The UE may monitor one or more reference signal candidate locations based at least in part on the at least one reference signal transmission pattern. Numerous other aspects are described.

### CROSS-REFERENCE TO RELATED APPLICATION

This Patent Application claims priority to U.S. Provisional Patent Application No. 63/718,114, filed on Nov. 8, 2024, entitled “AVAILABILITY OF SIGNALS IN TIME DIVISION DUPLEX MODE OF OPERATION,” and assigned to the assignee hereof. The disclosure of the prior Application is considered part of and is incorporated by reference into this Patent Application.

### FIELD OF THE DISCLOSURE

Aspects of the present disclosure generally relate to wireless communication and specifically relate to techniques, apparatuses, and methods associated with availability of signals in time division duplex mode of operation.

### BACKGROUND

Wireless communication systems are widely deployed to provide various services, which may involve carrying or supporting voice, text, other messaging, video, data, and/or other traffic. Typical wireless communication systems may employ multiple-access radio access technologies (RATs) capable of supporting communication among multiple wireless communication devices including user devices or other devices by sharing the available system resources (for example, time domain resources, frequency domain resources, spatial domain resources, and/or device transmit power, among other examples). Such multiple-access RATs are supported by technological advancements that have been adopted in various telecommunication standards, which define common protocols that enable different wireless communication devices to communicate on a local, municipal, national, regional, or global level.

An example telecommunication standard is New Radio (NR). NR, which may also be referred to as 5G, is part of a continuous mobile broadband evolution promulgated by the Third Generation Partnership Project (3GPP). NR (and other RATs beyond NR) may be designed to better support enhanced mobile broadband (eMBB) access, Internet of things (IoT) networks or reduced capability device deployments, and ultra-reliable low latency communication (URLLC) applications. To support these verticals, NR systems may be designed to implement a modularized functional infrastructure, a disaggregated and service-based network architecture, network function virtualization, network slicing, multi-access edge computing, millimeter wave (mmWave) technologies including massive multiple-input multiple-output (MIMO), licensed and unlicensed spectrum access, non-terrestrial network (NTN) deployments, sidelink and other device-to-device direct communication technologies (for example, cellular vehicle-to-everything (CV2X) communication), multiple-subscriber implementations, high-precision positioning, and/or radio frequency (RF) sensing, among other examples. As the demand for connectivity continues to increase, further improvements in NR may be implemented, and other RATs, such as 6G and beyond, may be introduced to enable new applications and facilitate new use cases.

### SUMMARY

Some aspects described herein relate to a user equipment (UE) for wireless communication. The UE may include one or more memories and one or more processors coupled to the one or more memories. The one or more processors may be configured to obtain an indication of a reference signal configuration associated with a time division duplex (TDD) mode of operation, wherein the reference signal configuration indicates at least one reference signal transmission pattern. The one or more processors may be configured to monitor one or more reference signal candidate locations based at least in part on the at least one reference signal transmission pattern.

Some aspects described herein relate to a network node for wireless communication. The network node may include one or more memories and one or more processors coupled to the one or more memories. The one or more processors may be configured to obtain an indication of a reference signal configuration associated with a TDD mode of operation, wherein the reference signal configuration indicates at least one reference signal transmission pattern. The one or more processors may be configured to transmit at least one reference signal according to the at least one reference signal transmission pattern.

Some aspects described herein relate to a method of wireless communication performed by a UE. The method may include obtaining an indication of a reference signal configuration associated with a TDD mode of operation, wherein the reference signal configuration indicates at least one reference signal transmission pattern. The method may include monitoring one or more reference signal candidate locations based at least in part on the at least one reference signal transmission pattern.

Some aspects described herein relate to a method of wireless communication performed by a network node. The method may include obtaining an indication of a reference signal configuration associated with a TDD mode of operation, wherein the reference signal configuration indicates at least one reference signal transmission pattern. The method may include transmitting at least one reference signal according to the at least one reference signal transmission pattern.

Some aspects described herein relate to a non-transitory computer-readable medium that stores a set of instructions for wireless communication by a UE. The set of instructions, when executed by one or more processors of the UE, may cause the UE to obtain an indication of a reference signal configuration associated with a TDD mode of operation, wherein the reference signal configuration indicates at least one reference signal transmission pattern. The set of instructions, when executed by one or more processors of the UE, may cause the UE to monitor one or more reference signal candidate locations based at least in part on the at least one reference signal transmission pattern.

Some aspects described herein relate to a non-transitory computer-readable medium that stores a set of instructions for wireless communication by a network node. The set of instructions, when executed by one or more processors of the network node, may cause the network node to obtain an indication of a reference signal configuration associated with a TDD mode of operation, wherein the reference signal configuration indicates at least one reference signal transmission pattern. The set of instructions, when executed by one or more processors of the network node, may cause the network node to transmit at least one reference signal according to the at least one reference signal transmission pattern.

Some aspects described herein relate to an apparatus for wireless communication. The apparatus may include means for obtaining an indication of a reference signal configuration associated with a TDD mode of operation, wherein the reference signal configuration indicates at least one reference signal transmission pattern. The apparatus may include means for monitoring one or more reference signal candidate locations based at least in part on the at least one reference signal transmission pattern.

Some aspects described herein relate to an apparatus for wireless communication. The apparatus may include means for obtaining an indication of a reference signal configuration associated with a TDD mode of operation, wherein the reference signal configuration indicates at least one reference signal transmission pattern. The apparatus may include means for transmitting at least one reference signal according to the at least one reference signal transmission pattern.

Aspects of the present disclosure may generally be implemented by or as a method, apparatus, system, computer program product, non-transitory computer-readable medium, user equipment, base station, network node, network entity, wireless communication device, and/or processing system as substantially described with reference to, and as illustrated by, this specification and accompanying drawings.

The foregoing paragraphs of this section have broadly summarized some aspects of the present disclosure. These and additional aspects and associated advantages will be described hereinafter. The disclosed aspects may be used as a basis for modifying or designing other aspects for carrying out the same or similar purposes of the present disclosure. Such equivalent aspects do not depart from the scope of the appended claims. Characteristics of the aspects disclosed herein, both their organization and method of operation, together with associated advantages, will be better understood from the following description when considered in connection with the accompanying drawings.

### BRIEF DESCRIPTION OF THE DRAWINGS

The appended drawings illustrate some aspects of the present disclosure but are not limiting of the scope of the present disclosure because the description may enable other aspects. Each of the drawings is provided for purposes of illustration and description, and not as a definition of the limits of the claims. The same or similar reference numbers in different drawings may identify the same or similar elements.

FIG. 1 is a diagram illustrating an example of a wireless communication network, in accordance with the present disclosure.

FIG. 2 is a diagram illustrating an example disaggregated network node architecture, in accordance with the present disclosure.

FIG. 3 is a diagram illustrating an example of a regenerative satellite deployment and an example of a transparent satellite deployment in a non-terrestrial network.

FIG. 4A is a diagram illustrating an example of a frame structure in a wireless communication network, and FIG. 4B is a diagram illustrating examples of slot configurations based on a time division duplex (TDD) pattern, in accordance with the present disclosure.

FIG. 5 is a diagram illustrating an example of antenna ports, in accordance with the present disclosure.

FIG. 6 is a diagram illustrating an example of a low duty cycle TDD operation, in accordance with the present disclosure.

FIG. 7 is a diagram illustrating an example of narrowband reference signal availability, in accordance with the present disclosure.

FIGS. 8A-8C are diagrams of examples associated with availability of signals in a TDD mode of operation, in accordance with the present disclosure.

FIG. 9 is a diagram illustrating an example process performed, for example, at a UE or an apparatus of a UE, in accordance with the present disclosure.

FIG. 10 is a diagram illustrating an example process performed, for example, at a network node or an apparatus of a network node, in accordance with the present disclosure.

FIGS. 11-12 are diagrams of example apparatuses for wireless communication, in accordance with the present disclosure.

### DETAILED DESCRIPTION

Various aspects of the present disclosure are described hereinafter with reference to the accompanying drawings. However, aspects of the present disclosure may be embodied in many different forms. The present disclosure is not to be construed as limited to any specific aspect illustrated by or described with reference to an accompanying drawing or otherwise presented in this disclosure. Rather, these aspects are provided so that this disclosure will be thorough and complete, and will fully convey the scope of the disclosure to those skilled in the art. One skilled in the art may appreciate that the scope of the disclosure is intended to cover any aspect of the disclosure disclosed herein, whether implemented independently of or in combination with any other aspect of the disclosure. For example, an apparatus may be implemented or a method may be practiced using various combinations or quantities of the aspects set forth herein. In addition, the scope of the disclosure is intended to cover an apparatus having, or a method that is practiced using, other structures and/or functionalities in addition to or other than the structures and/or functionalities with which various aspects of the disclosure set forth herein may be practiced. Any aspect of the disclosure disclosed herein may be embodied by one or more elements of a claim.

Several aspects of telecommunication systems will now be presented with reference to various methods, operations, apparatuses, and techniques. These methods, operations, apparatuses, and techniques will be described in the following detailed description and illustrated in the accompanying drawings by various blocks, modules, components, circuits, steps, processes, or algorithms (collectively referred to as “elements”). These elements may be implemented using hardware, software, or a combination of hardware and software. Whether such elements are implemented as hardware or software depends upon the particular application and design constraints imposed on the overall system.

As described above, wireless communication systems may be deployed to provide various services, which may involve carrying or supporting voice, text, other messaging, video, data, and/or other traffic. Some wireless communications systems may employ multiple-access radio access technologies (RATs). The multiple-access RATs may be capable of supporting communication with multiple wireless communication devices by sharing the available system resources (for example, time domain resources, frequency domain resources, spatial domain resources, and/or device transmit power, among other examples). Examples of such multiple-access RATs include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

Multiple-access RATs are supported by technological advancements that have been adopted in various telecommunication standards, which define common protocols that enable wireless communication devices to communicate on a local, municipal, enterprise, national, regional, or global level. For example, 5G New Radio (NR) is part of a continuous mobile broadband evolution promulgated by the Third Generation Partnership Project (3GPP). 5G NR may support enhanced mobile broadband (eMBB) access, Internet of Things (IoT) networks or reduced capability (RedCap) device deployments, ultra-reliable low-latency communication (URLLC) applications, and/or massive machine-type communication (mMTC), among other examples.

To support these and other target verticals, a wireless communication system may be designed to implement a modularized functional infrastructure, a disaggregated and service-based network architecture, network function virtualization, network slicing, multi-access edge computing, millimeter wave (mmWave) technologies including massive multiple-input multiple-output (MIMO), beamforming, IoT device or RedCap device connectivity and management, industrial connectivity, licensed and unlicensed spectrum access, sidelink and other device-to-device direct communication (for example, cellular vehicle-to-everything (CV2X) communication), frequency spectrum expansion, overlapping spectrum use, small cell deployments, non-terrestrial network (NTN) deployments, device aggregation, advanced duplex communication (for example, sub-band full-duplex (SBFD)), multiple-subscriber implementations, high-precision positioning, radio frequency (RF) sensing, network energy savings (NES), low-power signaling and radios, and/or artificial intelligence or machine learning (AI/ML), among other examples.

The foregoing and other technological improvements may support use cases, such as wireless fronthauls, wireless midhauls, wireless backhauls, wireless data centers, extended reality (XR) and metaverse applications, meta services for supporting vehicle connectivity, holographic and mixed reality communication, autonomous and collaborative robots, vehicle platooning and cooperative maneuvering, sensing networks, gesture monitoring, human-brain interfacing, digital twin applications, asset management, and universal coverage applications using non-terrestrial and/or aerial platforms, among other examples.

As the demand for connectivity continues to increase, further improvements in NR may be implemented, and other RATs, such as 6G and beyond, may be introduced to enable new applications and facilitate new use cases. The methods, operations, apparatuses, and techniques described herein may enable one or more of the foregoing technologies or new technologies and/or support one or more of the foregoing use cases or new use cases.

In a wireless network, different user equipments (UEs) may have different capabilities and may access the wireless network using different technologies. For example, some UEs may utilize narrowband (NB)-IoT technology, which is a low-power, wide-area (LPWA) networking technology that is designed for IoT devices. NB-IoT may operate in the licensed spectrum, making NB-IoT more secure and reliable relative to other LPWA technologies that may operate in unlicensed spectrum. NB-IoT provides low-cost connectivity to IoT devices, and supports a wide range of use cases, including metering, monitoring, and control of assets and devices. A UE that connects to an NB-IoT network may be referred to as an NB-IoT UE. Some examples of NB-IoT UEs include smart meters, asset trackers, and environmental monitoring devices.

Additionally, NB-IoT technology may be integrated into NTNs, which may refer to networks or network segments that include one or more non-terrestrial network nodes, such as a network node carried by a satellite, a balloon, a dirigible, an airplane, an unmanned aerial vehicle, a high altitude platform, and/or the like in different constellations to carry communications equipment (e.g., a network node and/or a relay node).

In some examples of an NB-IoT technology employed over an NTN, a low duty cycle time division duplex (TDD) operation mode may be enabled to increase power efficiency and reduce network congestion. For example, in a low duty cycle mode, devices may operate in an active state for a relatively small percentage or proportion of time and may operate in an inactive state for a relatively large percentage or proportion of time. The duty cycle may indicate the radio frame pattern over which transmissions occur (e.g., x out of N radio frames for uplink (UL) and y out of N radio frames used for downlink (DL), where x and y have the same or different values). The duty cycle may indicate a number of used transmission occasions per transmission period, where a duty cycle percentage or ratio may represent the fraction of the radio frames used for transmission (e.g., for UL or DL) in a radio frame pattern and a duty cycle period may define how often the radio frame pattern recurs.

However, in such a low duty cycle mode of NB-IoT NTN operation, there is a limited availability of DL resources to be used for channel estimation relative to normal duty cycle operation modes, resulting in degraded channel estimation accuracy and network performance. For example, the limited availability of DL resources may adversely affect channel estimation where the real-time UE measurements of a reference signal are updated infrequently. The decreased frequency of channel estimation may result in decoding of a DL signal being postponed to the next duty cycle, which may be a relatively long time period (e.g., multiple 90 millisecond (ms) time periods) relative to normal duty cycle operations.

Various aspects relate generally to a network node and/or a UE obtaining a reference signal configuration associated with a TDD mode of operation and including at least one reference signal transmission pattern. Some aspects more specifically relate to the network node transmitting reference signals according to the reference signal transmission pattern and the UE monitoring reference signal candidate locations associated with the reference signal transmission pattern. In some aspects, the TDD mode of operation may be associated with an NB-IoT NTN operation and/or with an NB-IoT DL subframe structure. In some aspects, the UE may monitor a first set of reference signal candidate locations associated with a first reference signal transmission pattern prior to decoding a SIB, and the UE may monitor a second set of reference signal candidate locations associated with a second reference signal transmission pattern after decoding the SIB. In some aspects, a first set of reference signal transmission patterns may be associated with an anchor carrier and a second set of reference signal transmission patterns may be associated with a non-anchor carrier. In some aspects, the reference signal transmission pattern may be associated with one or more always-on signals, such as a narrowband reference signal (NRS), a narrowband primary synchronization signal (NPSS), a narrowband secondary synchronization signal (NSSS), and/or a narrowband physical broadcast channel (NPBCH), and the reference signal transmission pattern and the always-on signal may be transmitted from a single antenna port.

Particular aspects of the subject matter described in this disclosure can be implemented to realize one or more of the following potential advantages. In some examples, the described techniques can be used to improve channel estimation by improving the availability of DL resources for reference signals, thereby enabling more opportunities for the UE to perform channel estimation. For example, the UE and network node assumptions as to reference signal availability may be adapted to increase network efficiency and reduce channel estimation errors in a low duty cycle NB-IoT NTN operation. The increase in frequency of reference signal transmission occasions may improve channel estimation by providing more accurate, real-time information on network conditions. For example, by improving channel estimation, the UE may adapt communications strategies (e.g., modifying encoding schemes, adjusting transmission power, or the like) to improve performance (e.g. accuracy and reliability) depending on network conditions, and the UE may provide more accurate and/or more frequent channel state information (CSI) feedback to the network node, enabling the network node to adapt communication strategies. Additionally, by using different reference signal transmission patterns before SIB decoding and after SIB decoding, the UE may adapt assumptions regarding the currently available DL resources for reference signals. Additionally, by indicating different reference signal transmission patterns and accompanying reference signal candidate locations for an anchor carrier and for a non-anchor carrier, the network node and UE may be able to flexibly adapt reference signal patterns to anchor carrier and non-anchor carrier scenarios. Additionally, by utilizing the single antenna port to transmit both the reference signal and the always-on signal, the UE may utilize both the reference signal and the always-on signal in channel estimation, thereby decreasing error rates and increasing channel estimation efficiency.

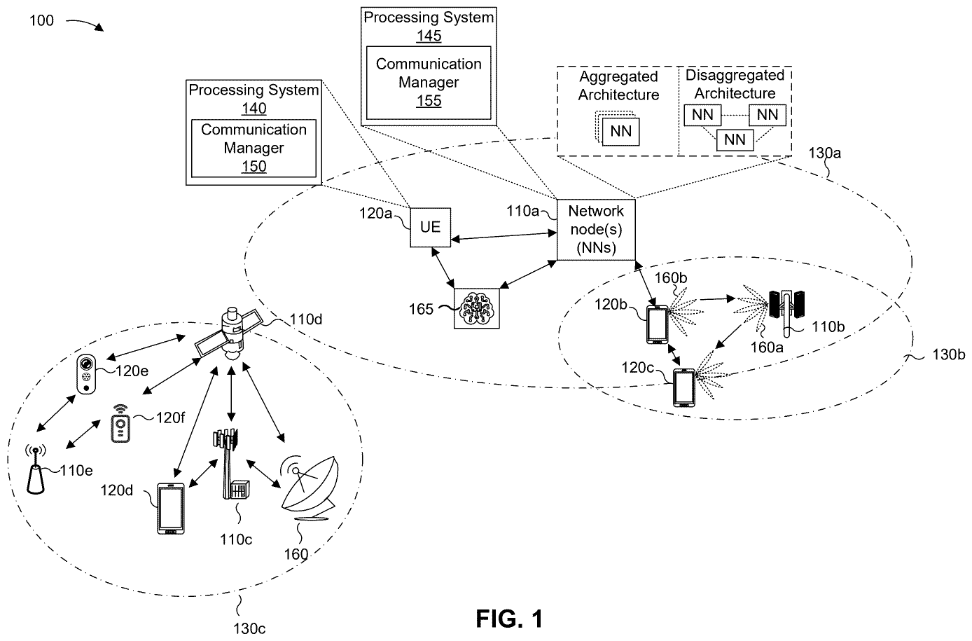

FIG. 1 is a diagram illustrating an example of a wireless communication network 100, in accordance with the present disclosure. The wireless communication network 100 may be or may include elements of a 5G (or NR) network or a 6G network, among other examples. The wireless communication network 100 may include multiple network nodes 110. For example, in FIG. 1, the wireless communication network 100 includes a network node (NN) 110a, a network node 110b, a network node 110c, a network node 110d, and a network node 110e. The network nodes 110 may support communications with multiple UEs 120. For example, in FIG. 1, the network nodes 110 support communication with a UE 120a, a UE 120b, a UE 120c, and a UE 120d. In some examples, a UE 120 may also communicate with other UEs 120 and a network node 110 may communicate with a core network and with other network nodes 110.

The network nodes 110 and the UEs 120 of the wireless communication network 100 may communicate using the electromagnetic spectrum, which may be subdivided by frequency or wavelength into various classes, bands, carriers, and/or channels. For example, devices of the wireless communication network 100 may communicate using one or more operating bands. In some aspects, multiple wireless communication networks 100 may be deployed in a given geographic area. Each wireless communication network 100 may support a particular RAT (which may also be referred to as an air interface) and may operate on one or more carrier frequencies in one or more frequency bands or ranges. In some examples, when multiple RATs are deployed in a given geographic area, each RAT in the geographic area may operate on different frequencies to avoid interference with other RATs. Additionally,5 or alternatively, in some examples, the wireless communication network 100 may implement dynamic spectrum sharing (DSS), in which multiple RATs are implemented with dynamic bandwidth allocation (for example, based on user demand) in a single frequency band. In some examples, the wireless communication network 100 may support communication over unlicensed spectrum, where access to an unlicensed channel is subject to a channel access mechanism. For example, in a shared or unlicensed frequency band, a transmitting device may perform a channel access procedure, such as a listen-before-talk (LBT) procedure, to contend against other devices for channel access before transmitting on a shared or unlicensed channel.

Various operating bands have been defined as frequency range designations FR1 (410 MHz through 7.125 GHz), FR2 (24.25 GHz through 52.6 GHz), FR3 (7.125 GHz through 24.25 GHz), FR4a or FR4-1 (52.6 GHz through 71 GHz), FR4 (52.6 GHz through 114.25 GHz), and FR5 (114.25 GHz through 300 GHz). Although a portion of FR1 is greater than 6 GHz, FR1 is often referred to (interchangeably) as a “sub-6 GHz” band in some documents and articles. Similarly, FR2 is often referred to (interchangeably) as a “millimeter wave” band in some documents and articles, despite being different than the extremely high frequency (EHF) band (30 GHz through 300 GHz), which is identified by the International Telecommunications Union (ITU) as a “millimeter wave” band. The frequencies between FR1 and FR2 are often referred to as mid-band frequencies, which include FR3. Frequency bands falling within FR3 may inherit FR1 characteristics or FR2 characteristics, and thus may effectively extend features of FR1 or FR2 into the mid-band frequencies. Thus, “sub-6 GHz,” if used herein, may broadly refer to frequencies that are less than 6 GHz, that are within FR1, and/or that are included in mid-band frequencies. Similarly, the term “millimeter wave,” if used herein, may broadly refer to mid-band frequencies or to frequencies that are within FR2, FR4, FR4-a or FR4-1, FR5, and/or the EHF band. Higher frequency bands may extend 5G NR operation, 6G operation, and/or other RATs beyond 52.6 GHz.

A network node 110 and/or a UE 120 may include one or more devices, components, or systems that enable communication with other devices, components, or systems of the wireless communication network 100. For example, a UE 120 and a network node 110 may each include one or more chips, system-on-chips (SoCs), chipsets, packages, or devices that individually or collectively constitute or comprise a processing system, such as a processing system 140 of the UE 120 or a processing system 145 of the network node 110. A processing system (for example, the processing system 140 and/or the processing system 145) includes processor (or “processing”) circuitry in the form of one or multiple processors, microprocessors, processing units (such as central processing units (CPUs), graphics processing units (GPUs), neural processing units (NPUs) (also referred to as neural network processors or deep learning processors (DLPs)), and/or digital signal processors (DSPs)), processing blocks, application-specific integrated circuits (ASICs), programmable logic devices (PLDs), or other discrete gate or transistor logic or circuitry (any one or more of which may be generally referred to herein individually as a “processor” or collectively as “the processor” or “the processor circuitry”). Such processors may be individually or collectively configurable or configured to perform various functions or operations described herein. A group of processors collectively configurable or configured to perform a set of functions may include a first processor configurable or configured to perform a first function of the set and a second processor configurable or configured to perform a second function of the set. In some other examples, each of a group of processors may be configurable or configured to perform a same set of functions.

The processing system 140 and the processing system 145 may each include memory circuitry in the form of one or multiple memory devices, memory blocks, memory elements, or other discrete gate or transistor logic or circuitry, each of which may include or implement tangible storage media such as random-access memory (RAM) or read-only memory (ROM), or combinations thereof (any one or more of which may be generally referred to herein individually as a “memory” or collectively as “the memory” or “the memory circuitry”). One or more of the memories may be coupled (for example, operatively coupled, communicatively coupled, electronically coupled, or electrically coupled) with one or more of the processors and may individually or collectively store processor-executable code or instructions (such as software) that, when executed by one or more of the processors, may configure one or more of the processors to perform various functions or operations described herein. Additionally, or alternatively, in some examples, one or more of the processors may be configured to perform various functions or operations described herein without requiring configuration by software. “Software” shall be construed broadly to mean instructions, instruction sets, code, code segments, program code, programs, subprograms, software modules, applications, software applications, software packages, routines, subroutines, objects, executables, threads of execution, procedures, or functions, among other examples, whether referred to as software, firmware, middleware, microcode, hardware description language, or otherwise.

The processing system 140 and the processing system 145 may each include or be coupled with one or more modems (such as a cellular (for example, a 5G or 6G compliant) modem). In some examples, one or more processors of the processing system 140 and/or the processing system 145 include or implement one or more of the modems. The processing system 140 and the processing system 145 may also include or be coupled with multiple radios (collectively “the radio”), multiple RF chains, or multiple transceivers, each of which may in turn be coupled with one or more of multiple antennas. In some examples, one or more processors of the processing system 140 and/or the processing system 145 include or implement one or more of the radios, RF chains, or transceivers. An RF chain may include one or more filters, mixers, oscillators, amplifiers, analog-to-digital converters (ADCs), and/or other devices that convert between an analog signal (such as for transmission or reception via an air interface) and a digital signal (such as for processing by the processing system 140 of the UE 120 or by the processing system 145 of the network node 110).

A network node 110 and a UE 120 may each include one or multiple antennas or antenna arrays. Typical network nodes 110 and UEs 120 may include multiple antennas, which may be organized or structured into one or more antenna panels, one or more antenna groups, one or more sets of antenna elements, or one or more antenna arrays, among other examples. As used herein, the term “antenna” can refer to one or more antennas, one or more antenna panels, one or more antenna groups, one or more sets of antenna elements, or one or more antenna arrays. The term “antenna panel” can refer to a group of antennas (such as antenna elements) arranged in an array or panel, which may facilitate beamforming by manipulating parameters associated with the group of antennas. The term “antenna module” may refer to circuitry including one or more antennas as well as one or more other components (such as filters, amplifiers, or processors) associated with integrating the antenna module into a wireless communication device such as the network node 110 and the UE 120.

A network node 110 may be, may include, or may also be referred to as an NR network node, a 5G network node, a 6G network node, a Node B, a gNB, an access point (AP), a transmission reception point (TRP), a network entity, a network element, a network equipment, and/or another type of device, component, or system included in a radio access network (RAN). In various deployments, a network node 110 may be implemented as a single physical node (for example, a single physical structure) or may be implemented as two or more physical nodes (for example, two or more distinct physical structures). For example, a network node 110 may be a device or system that implements a part of a radio protocol stack, a device or system that implements a full radio protocol stack (such as a full gNB protocol stack), or a collection of devices or systems that collectively implement the full radio protocol stack. For example, and as shown, a network node 110 may be an aggregated network node having an aggregated architecture, meaning that the network node 110 may implement a full radio protocol stack that is physically and logically integrated within a single physical structure in the wireless communication network 100. For example, an aggregated network node 110 may consist of a single standalone base station or a single TRP that operates with a full radio protocol stack to enable or facilitate communication between a UE 120 and a core network of the wireless communication network 100.

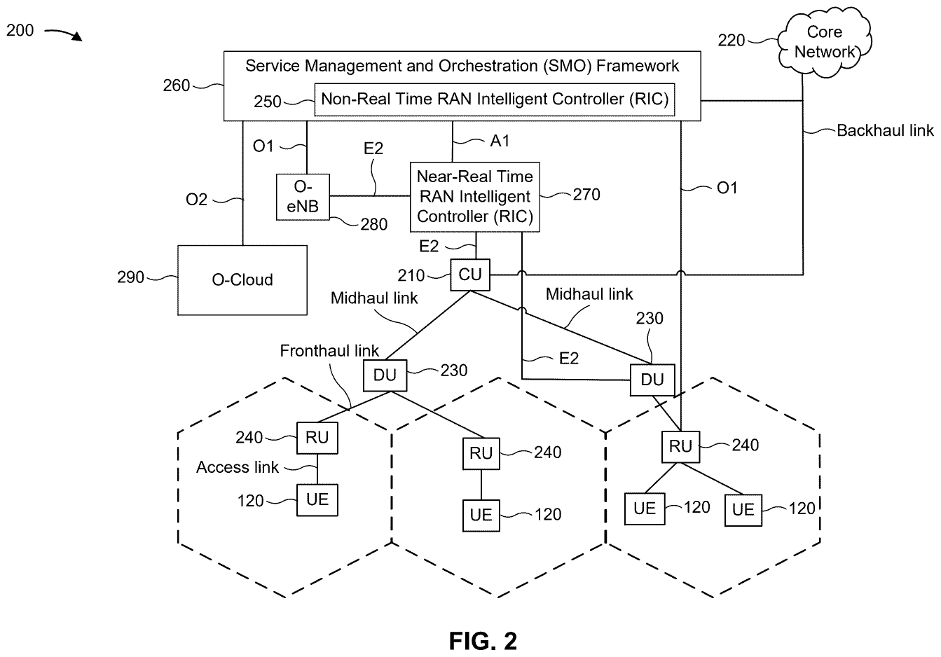

Alternatively, and as also shown, a network node 110 may be a disaggregated network node (sometimes referred to as a disaggregated base station), having a disaggregated architecture, meaning that the network node 110 may operate with a radio protocol stack that is physically distributed and/or logically distributed among two or more nodes in the same geographic location or in different geographic locations. An example disaggregated network node architecture is described in more detail below with reference to FIG. 2. In some deployments, disaggregated network nodes 110 may be used in an integrated access and backhaul (IAB) network, in an open radio access network (O-RAN) (such as a network configuration in compliance with the O-RAN Alliance), or in a virtualized radio access network (vRAN), also known as a cloud radio access network (C-RAN), to facilitate scaling by separating network functionality into multiple units or modules that can be individually deployed.

The network nodes 110 of the wireless communication network 100 may include one or more central units (CUs), one or more distributed units (DUs), and one or more radio units (RUs). A CU may host one or more higher layers, such as a radio resource control (RRC) layer, a packet data convergence protocol (PDCP) layer, and a service data adaptation protocol (SDAP) layer, among other examples. A DU may host one or more of a radio link control (RLC) layer, a medium access control (MAC) layer, and/or one or more higher physical (PHY) layers depending, at least in part, on a functional split, such as a functional split defined by the 3GPP. In some examples, a DU also may host a lower PHY layer that is configured to perform functions, such as a fast Fourier transform (FFT), an inverse FFT (IFFT), beamforming, and/or physical random access channel (PRACH) extraction and filtering, among other examples. An RU may perform RF processing functions or lower PHY layer functions, such as an FFT, an IFFT, beamforming, or PRACH extraction and filtering, among other examples, according to a functional split, such as a lower layer split (LLS). In such an architecture, each RU can be operated to handle over the air (OTA) communication with one or more UEs 120. In some examples, a single network node 110 may include a combination of one or more CUs, one or more DUs, and/or one or more RUs. In some examples, a CU, a DU, and/or an RU may be implemented as a virtual unit, such as a virtual central unit (VCU), a virtual distributed unit (VDU), or a virtual radio unit (VRU), among other examples, which may be implemented as a virtual network function, such as in a cloud deployment.

Some network nodes 110 (for example, a base station, an RU, or a TRP) may provide communication coverage for a particular geographic area. The term “cell” can refer to a coverage area of a network node 110 or to a network node 110 itself, depending on the context in which the term is used. A network node 110 may support one or more cells (for example, each cell may support communication within an angular (for example, 60 degree) range around the network node). In some examples, a network node 110 may provide communication coverage for a macro cell, a pico cell, a femto cell, or another type of cell. A macro cell may cover a relatively large geographic area (for example, several kilometers in radius) and may allow unrestricted access by UEs 120 with associated service subscriptions. A pico cell may cover a relatively small geographic area and may also allow unrestricted access by UEs 120 with associated service subscriptions. A femto cell may cover a relatively small geographic area (for example, a home) and may allow restricted access by UEs 120 having association with the femto cell (for example, UEs 120 in a closed subscriber group (CSG)). In some examples, a cell may not necessarily be stationary. For example, the geographic area of the cell may move according to the location of an associated mobile network node 110 (for example, a train, a satellite, an unmanned aerial vehicle, or an NTN network node).

The wireless communication network 100 may be a heterogeneous network that includes network nodes 110 of different types, such as macro network nodes, pico network nodes, femto network nodes, relay network nodes, aggregated network nodes, and/or disaggregated network nodes, among other examples. Various different types of network nodes 110 may generally transmit at different power levels, serve different coverage areas (for example, a cell 130a, a cell 130b, and a cell 130c), and/or have different impacts on interference in the wireless communication network 100 than other types of network nodes 110.

As indicated above, a network node 110 may be a terrestrial network node 110 (for example, a terrestrial base station or entity of a disaggregated base station) or an NTN network node 110. In the example shown in FIG. 1, the network node 110d may be an NTN network node 110 and the cell 130c may be an NTN cell. For example, the wireless communication network 100 may include one or more NTN deployments including an NTN network node 110 and/or a relay station. In some examples, a relay station in an NTN deployment may be referred to as a “non-terrestrial relay station.” An NTN may facilitate access to the wireless communication network 100 for remote areas that may not otherwise be within a coverage area of a terrestrial network node 110, such as over water or remote areas in which a terrestrial network is not deployed. An NTN may provide connectivity for various applications, including satellite communications, IoT, MTC, and/or other applications. An NTN network node 110 may include a satellite, a manned aircraft system, or an unmanned aircraft system (UAS) platform, among other examples. A satellite may include a low-earth orbit (LEO) satellite, a medium-earth orbit (MEO) satellite, a geostationary earth orbit (GEO) satellite, and/or a high elliptical orbit (HEO) satellite, among other examples. A manned aircraft system may include an airplane, a helicopter, and/or a dirigible, among other examples. A UAS platform may include a high-altitude platform station (HAPS), a balloon, a dirigible, and/or an airplane, among other examples.

An NTN network node 110 may communicate directly and/or indirectly with other entities in the wireless communication network 100 using NTN communication. The other entities may include UEs 120 (for example, the UE 120d, the UE 120e, and/or the UE 120f), other NTN network nodes 110 in the one or more NTN deployments, other types of network nodes 110 (for example, stationary, terrestrial, and/or ground-based network nodes, such as the network node 110c), relay stations, and/or one or more components and/or devices included in or coupled with a core network of the wireless communication network 100. For example, an NTN network node 110 may communicate with a UE 120 via a service link (for example, where the service link includes an access link). Additionally, or alternatively, an NTN network node 110 may communicate with a gateway 160 (for example, a terrestrial node providing connectivity for the NTN network node 110 to a data network or a core network) via a feeder link (for example, where the feeder link is associated with an N2 or an N3 interface). Additionally, or alternatively, NTN network nodes 110 may communicate directly with one another via an inter-satellite link (ISL). In some examples, an NTN deployment may be transparent (for example, where the NTN network node 110 operates in a similar manner as a repeater or relay and/or where an access link does not terminate at the NTN network node 110). In some other examples, an NTN deployment may be regenerative. For example, an access link may terminate at the NTN network node 110, and the NTN network node 110 may regenerate a signal (such as by performing signal processing or enhancement, which may include error correction, modulation or demodulation, or amplification).

The UEs 120 may be physically dispersed throughout the coverage area of the wireless communication network 100, and each UE 120 may be stationary or mobile. A UE 120 may be, may include, or may also be referred to as an access terminal, a mobile station, or a subscriber unit. A UE 120 may be, include, or be coupled with a cellular phone (for example, a smart phone), a personal digital assistant (PDA), a wireless modem, a wireless communication device, a handheld device, a laptop computer, a cordless phone, a wireless local loop (WLL) station, a tablet, a camera, a netbook, a smartbook, an ultrabook, a medical device, a biometric device, a wearable device (for example, a smart watch, smart clothing, smart glasses, a smart wristband, or smart jewelry), a gaming device, an entertainment device (for example, a music device, a video device, or a satellite radio), an XR device, a vehicular component or sensor, a smart meter or sensor, industrial manufacturing equipment, a Global Navigation Satellite System (GNSS) device (such as a Global Positioning System device or another type of positioning device), a UE function of a network node, and/or any other suitable device or function that may communicate via a wireless medium.

Some UEs 120 may be considered machine-type communication (MTC) UEs, evolved or enhanced machine-type communication (eMTC) UEs, further enhanced eMTC (feMTC) UEs, or enhanced feMTC (efeMTC) UEs, or further evolutions thereof, all of which may be simply referred to as “MTC UEs.” For example, the UE 120e and/or the UE 120f may be an MTC UE. An MTC UE may be, may include, or may be included in or coupled with a robot, an uncrewed aerial vehicle, a remote device, a sensor, a meter, a monitor, and/or a location tag. Some UEs 120 may be considered IoT devices. Some such UEs 120 may be implemented as NB-IoT devices, such as the UE 120f. An IoT device or NB-IoT device may be, may include, or may be included in or coupled with an industrial machine, an appliance, a refrigerator, a doorbell camera device, a home automation device, and/or a light fixture, among other examples. Some UEs 120 may be considered Customer Premises Equipment (CPEs), which may include telecommunications devices that are installed at a customer location (such as a home or office) to enable access to a service provider's network (such as included in or in communication with the wireless communication network 100).

Some UEs 120 may be classified according to different categories in association with different complexities and/or different capabilities. UEs 120 in a first category may facilitate massive IoT in the wireless communication network 100, and may offer low complexity and/or cost relative to UEs 120 in a second category. UEs 120 in a second category may include mission-critical IoT devices, legacy UEs, baseline UEs, high-tier UEs, advanced UEs, full-capability UEs, and/or premium UEs that are capable of URLLC, eMBB, and/or precise positioning in the wireless communication network 100, among other examples. A third category of UEs 120 may have mid-tier complexity and/or capability (for example, a capability between that of the UEs 120 of the first category and that of the UEs 120 of the second capability). A UE 120 of the third category may be referred to as a reduced capability UE (“RedCap UE”), a mid-tier UE, an NR-Light UE, and/or an NR-Lite UE, among other examples. RedCap UEs may bridge a gap between the capability and complexity of NB-IoT devices and/or eMTC UEs, and mission-critical IoT devices and/or premium UEs. RedCap UEs may include, for example, wearable devices, IoT devices, industrial sensors, or cameras that are associated with a limited bandwidth, power capacity, and/or transmission range, among other examples. RedCap UEs may support healthcare environments, building automation, electrical distribution, process automation, transport and logistics, or smart city deployments, among other examples.

In some examples, a network node 110 may be, may include, or may operate as an RU, a TRP, or a base station that communicates with one or more UEs 120 via a radio access link (which may be referred to as a “Uu” link). The radio access link may include a downlink and an uplink. “Downlink” (or “DL”) refers to a communication direction from a network node 110 to a UE 120, and “uplink” (or “UL”) refers to a communication direction from a UE 120 to a network node 110. Downlink and uplink resources may include time domain resources (for example, frames, subframes, slots, and symbols), frequency domain resources (for example, frequency bands, component carriers (CCs), subcarriers, resource blocks, and resource elements), and spatial domain resources (for example, particular transmit directions or beams).

Frequency domain resources may be subdivided into bandwidth parts (BWPs). A BWP may be a block of frequency domain resources (for example, a continuous set of resource blocks (RBs) within a full component carrier bandwidth) that may be configured at a UE-specific level. A UE 120 may be configured with both an uplink BWP and a downlink BWP (which may be the same or different). Each BWP may be associated with its own numerology (indicating a sub-carrier spacing (SCS) and cyclic prefix (CP)). A BWP may be dynamically configured or activated (for example, by a network node 110 transmitting a downlink control information (DCI) configuration to the one or more UEs 120) and/or reconfigured (for example, in real-time or near-real-time) according to changing network conditions in the wireless communication network 100 and/or specific requirements of one or more UEs 120. An active BWP defines the operating bandwidth of the UE 120 within the operating bandwidth of the serving cell. The use of BWPs enables more efficient use of the available frequency domain resources in the wireless communication network 100 because fewer frequency domain resources may be allocated to a BWP for a UE 120 (which may reduce the quantity of frequency domain resources that a UE 120 is required to monitor and reduce UE power consumption by enabling the UE to monitor fewer frequency domain resources), leaving more frequency domain resources to be spread across multiple UEs 120. Thus, BWPs may also assist in the implementation of lower-capability (for example, RedCap) UEs 120 by facilitating the configuration of smaller bandwidths for communication by such UEs 120 and/or by facilitating reduced UE power consumption.

As used herein, a downlink signal may be or include a reference signal, control information, or data. For example, downlink reference signals include a primary synchronization signal (PSS), a secondary SS (SSS), an SS block (SSB) (for example, that includes a PSS, an SSS, and a physical broadcast channel (PBCH)), a demodulation reference signal (DMRS), a phase tracking reference signal (PTRS), a tracking reference signal (TRS), and a CSI reference signal (CSI-RS), among other examples. Additionally, downlink reference signals may include always-on signals, including an NRS, an NPSS, an NSSS, and an NPBCH signal. A downlink signal carrying control information or data may be transmitted via a downlink channel. Downlink channels may include one or more control channels for transmitting control information and one or more data channels for transmitting data. Downlink reference signals may be transmitted in addition to, or multiplexed with, downlink control channel communications and/or downlink data channel communications. A downlink control channel may be specifically used to transmit DCI from a network node 110 to a UE 120. DCI generally contains the information the UE 120 needs to identify RBs in a subsequent subframe and how to decode them, including a modulation and coding scheme (MCS) or redundancy version parameters. Different DCI formats carry different information, such as scheduling information in the form of downlink or uplink grants, slot format indicators (SFIs), preemption indicators (PIs), transmit power control (TPC) commands, hybrid automatic repeat request (HARQ) information, new data indicators (NDIs), among other examples. A downlink data channel may be used to transmit downlink data (for example, user data associated with a UE 120) from a network node 110 to a UE 120. Downlink control channels may include physical downlink control channels (PDCCHs), and downlink data channels may include physical downlink shared channels (PDSCHs). Control information or data communications may be transmitted on a PDCCH and PDSCH, respectively. For example, a PDCCH can carry DCI, while a PDSCH can carry a MAC control element (MAC-CE), an RRC message, or user data, among other examples. Each PDSCH may carry one or more transport blocks (TBs) of data.

As used herein, an uplink signal may include a reference signal, control information, or data. For example, uplink reference signals include a sounding reference signal (SRS), a PTRS, and a DMRS, among other examples. An uplink signal carrying control information or data may be transmitted via an uplink channel. An uplink channel may include one or more control channels for transmitting control information and one or more data channels for transmitting data. Uplink reference signals may be transmitted in addition to, or multiplexed with, uplink control channel communications and/or uplink data channel communications. An uplink control channel may be specifically used to transmit uplink control information (UCI) from a UE 120 to a network node 110. An uplink data channel may be used to transmit uplink data (for example, user data associated with a UE 120) from a UE 120 to a network node 110. Uplink control channels may include physical uplink control channels (PUCCHs), and uplink data channels may include physical uplink shared channels (PUSCHs). Control information or data communications may be transmitted on a PUCCH and PUSCH, respectively. For example, a PUCCH can carry UCI, while a PUSCH can carry a MAC-CE, an RRC message, or user data, among other examples. UCI can include a scheduling request (SR), HARQ feedback information (for example, a HARQ acknowledgement (ACK) indication or a HARQ negative acknowledgement (NACK) indication), uplink power control information (for example, an uplink TPC parameter), and/or CSI, among other examples. CSI can include a channel quality indicator (CQI) (indicative of downlink channel conditions to facilitate selection of transmission parameters, such as an MCS, by a network node 110), a precoding matrix indicator (PMI), a CSI-RS resource indicator (CRI) (for example, indicative of a beam used to transmit a CSI-RS), an SS/PBCH resource block indicator (SSBRI) (for example, indicative of a beam used to transmit an SSB), a layer indicator (LI), a rank indicator (RI), and/or measurement information (for example, a layer 1 (L1)-reference signal received power (RSRP) parameter, a received signal strength indicator (RSSI) parameter, a reference signal received quality (RSRQ) parameter, among other examples) which can be used for beam management, among other examples. Each PUSCH may carry one or more TBs of data.

The information (for example, data, control information, or reference signal information) transmitted by a network node 110 to a UE 120, or vice versa, may be represented as a sequence of binary bits that are mapped (for example, modulated) to an analog signal waveform (for example, a discrete Fourier transform (DFT)-spread-orthogonal frequency division multiplexing (OFDM) (DFT-s-OFDM) waveform or a CP-OFDM waveform) that is transmitted by the network node 110 or UE 120 over a wireless communication channel. In some examples, the network node 110 or the UE 120 (for example, using the processing system 145 or the processing system 140, respectively) may select an MCS (for example, an order of quadrature amplitude modulation (QAM), such as 64-QAM, 128-QAM, or 256-QAM, among other examples) for a downlink signal or an uplink signal. For example, the network node 110 may select an MCS for a downlink signal in accordance with UCI received from the UE 120. The network node 110 may transmit, to the UE 120, an indication of the selected MCS for the downlink signal, such as via DCI that schedules the downlink signal. As another example, the network node 110 may transmit, and the UE 120 may receive, an indication of an MCS to be applied for the one or more uplink signals, such as via DCI scheduling transmission of the one or more uplink signals.

The network node 110 or the UE 120 (such as by using the processing system 145 or the processing system 140, respectively, and/or one or more coupled modems) may perform signal processing on the information (such as filtering, amplification, modulation, digital-to-analog conversion, an IFFT operation, multiplexing, interleaving, mapping, and/or encoding, among other examples) to generate a processed signal in accordance with the selected MCS. In some examples, the network node 110 or the UE 120 (for example, using the processing system 145 or the processing system 140, respectively, and/or one or more coupled encoders or modems) may perform a channel coding operation or a forward error correction (FEC) operation to control errors in transmitted information. For example, the network node 110 or the UE 120 may perform an encoding operation to generate encoded information (such as by selectively introducing redundancy into the information, typically using an error correction code (ECC), such as a polar code or a low-density parity-check (LDPC) code). The network node 110 or the UE 120 (for example, using the processing system 145 and/or one or more modems) may further perform spatial processing (for example, precoding) on the encoded information to generate one or more processed or precoded signals for downlink or uplink transmission, respectively. In some examples, the network node 110 or the UE 120 may perform codebook-based precoding or non-codebook-based precoding. Codebook-based precoding may involve selecting a precoder (for example, a precoding matrix) using a codebook. For example, the network node 110 may provide precoding information indicating which precoder, defined by the codebook, is to be used by the UE 120. Non-codebook-based precoding may involve selecting or deriving a precoder based on, or otherwise associated with, one or more downlink or uplink signal measurements. The network node 110 or the UE 120 may transmit the processed downlink or uplink signals, respectively, via one or more antennas.

The network node 110 or the UE 120 may receive uplink signals or downlink signals, respectively, via one or more antennas. The network node 110 or the UE 120 (for example, using the processing system 145 or the processing system 140, respectively, and/or one or more coupled modems) may perform signal processing (for example, in accordance with the MCS) on the received uplink or downlink signals, respectively (such as filtering, amplification, demodulation, analog-to-digital conversion, an FFT operation, demultiplexing, deinterleaving, de-mapping, equalization, interference cancellation, and/or decoding, among other examples), to map the received signal(s) to a sequence of binary bits (for example, received information) that estimates the information transmitted by the network node 110 or the UE 120 via the downlink or uplink signals. The network node 110 or the UE 120 (for example, using the processing system 145 or the processing system 140, respectively, and/or a coupled decoder or one or more modems) may decode the received information (such as by using an ECC, a decoding operation, and/or an FEC operation) to detect errors and/or correct bit errors in the received information to generate decoded information. The decoded information may estimate the information transmitted via the downlink or uplink signals.

In some examples, a UE 120 and a network node 110 may perform MIMO communication. “MIMO” generally refers to transmitting or receiving multiple signals (such as multiple layers or multiple data streams) simultaneously over the same time and frequency resources. MIMO techniques generally exploit multipath propagation. A network node 110 and/or UE 120 may communicate using massive MIMO, multi-user MIMO, or single-user MIMO, which may involve rapid switching between beams or cells. For example, the amplitudes and/or phases of signals transmitted via antenna elements and/or sub-elements may be modulated and shifted relative to each other (such as by manipulating a phase shift, a phase offset, and/or an amplitude) to generate one or more beams, which is referred to as beamforming. For example, the network node 110b may generate one or more beams 160a, and the UE 120b may generate one or more beams 160b. The term “beam” may refer to a directional transmission of a wireless signal toward a receiving device or otherwise in a desired direction, a directional reception of a wireless signal from a transmitting device or otherwise in a desired direction, a direction associated with a directional transmission or directional reception, a set of directional resources associated with a signal transmission or signal reception (for example, an angle of arrival, a horizontal direction, and/or a vertical direction), a set of parameters that indicate one or more aspects of a directional signal, a direction associated with the signal, and/or a set of directional resources associated with the signal, among other examples.

MIMO may be implemented using various spatial processing or spatial multiplexing operations. In some examples, MIMO may include a massive MIMO technique which may be associated with an increased (for example, “massive”) quantity of antennas at the network node 110 and/or at the UE 120, such as in a network implementing mmWave technology. Massive MIMO may improve communication reliability by enabling a network node 110 and/or a UE 120 to communicate the same data across different propagation (or spatial) paths. In some examples, MIMO may support simultaneous transmission to multiple receivers, referred to as multi-user MIMO (MU-MIMO). Some RATs may employ MIMO techniques, such as multi-TRP (mTRP) operation (including redundant transmission or reception on multiple TRPs), reciprocity in the time domain or the frequency domain, single-frequency-network transmission, or non-coherent joint transmission (NC-JT).

To support MIMO techniques, the network node 110 and the UE 120 may perform one or more beam management operations, such as an initial beam acquisition operation, one or more beam refinement operations, and/or a beam recovery operation. For example, an initial beam acquisition operation may involve the network node 110 transmitting signals (for example, SSBs, CSI-RSs, or other signals) via respective beams (for example, of the beams 160a of the network node 110) and the UE 120 receiving and measuring the signal(s) via respective beams of multiple beams (for example, from the beams 160b of the UE 120) to identify a best beam (or beam pair) for communication between the UE 120 and the network node 110. For example, the UE 120 may transmit an indication (for example, in a message associated with a random access channel (RACH) operation) of a (best) identified beam of the network node 110 (for example, by indicating an SSBRI or other identifier associated with the beam). A beam refinement operation may involve a first device (for example, the UE 120 or the network node 110) transmitting signal(s) via a subset of beams (for example, identified based on, or otherwise associated with, measurements reported as part of one or more other beam management operations). A second device (for example, the network node 110 or the UE 120) may receive the signal(s) via a single beam (for example, to identify the best beam for communication from the subset of beams). The beam(s) may be identified via one or more spatial parameters, such as a transmission configuration indicator (TCI) state and/or a quasi co-location (QCL) parameter, among other examples. The network node 110 and the UE 120 may increase reliability and/or achieve efficiencies in throughput, signal strength, and/or other signal properties for massive MIMO operations by performing the beam management operations.

Some aspects and techniques as described herein may be implemented, at least in part, using an artificial intelligence (AI) program (for example, referred to herein as an “AI/ML model”), such as a program that includes a machine learning (ML) model and/or an artificial neural network (ANN) model. The AI/ML model may be deployed at one or more devices 165 (for example, a network node 110 and/or UEs 120). For example, the one or more devices 165 may include a UE 120 (for example, the processing system 140), a network node 110 (for example, the processing system 145), one or more servers, and/or one or more components of a cloud computing network, among other examples. In some examples, the AI/ML model (or an instance of the AI/ML model) may be deployed at multiple devices (for example, a first portion of the AI/ML model may be deployed at a UE 120 and a second portion of the AI/ML model may be deployed at a network node 110). In other examples, a first AI/ML model may be deployed at a UE 120 and a second AI/ML model may be deployed at a network node 110. The AI/ML model(s) may be configured to enhance various aspects of the wireless communication network 100. For example, the AI/ML model(s) may be trained to identify patterns or relationships in data corresponding to the wireless communication network 100, a device, and/or an air interface, among other examples. The AI/ML model(s) may support operational decisions relating to one or more aspects associated with wireless communications devices, networks, or services.

In some aspects, the UE 120 may include a communication manager 150. As described in more detail elsewhere herein, the communication manager 150 may obtain an indication of a reference signal configuration associated with a TDD mode of operation, wherein the reference signal configuration indicates at least one reference signal transmission pattern; and monitor one or more reference signal candidate locations based at least in part on the at least one reference signal transmission pattern. Additionally, or alternatively, the communication manager 150 may perform one or more other operations described herein.

In some aspects, the network node 110 may include a communication manager 155. As described in more detail elsewhere herein, the communication manager 155 may obtain an indication of a reference signal configuration associated with a TDD mode of operation, wherein the reference signal configuration indicates at least one reference signal transmission pattern; and transmit at least one reference signal according to the at least one reference signal transmission pattern. Additionally, or alternatively, the communication manager 155 may perform one or more other operations described herein.

FIG. 2 is a diagram illustrating an example disaggregated network node architecture 200, in accordance with the present disclosure. One or more components of the example disaggregated network node architecture 200 may be, may include, or may be included in one or more network nodes (such one or more network nodes 110). The disaggregated network node architecture 200 may include a CU 210 that can communicate directly with a core network 220 via a backhaul link, or that can communicate indirectly with the core network 220 via one or more disaggregated control units, such as a non-real-time (Non-RT) RAN intelligent controller (RIC) 250 associated with a Service Management and Orchestration (SMO) Framework 260 and/or a near-real-time (Near-RT) RIC 270 (for example, via an E2 link). The CU 210 may communicate with one or more DUs 230 via respective midhaul links, such as via F1 interfaces. Each of the DUs 230 may communicate with one or more RUs 240 via respective fronthaul links. Each of the RUs 240 may communicate with one or more UEs 120 via respective RF access links. In some deployments, a UE 120 may be simultaneously served by multiple RUs 240.

Each of the components of the disaggregated network node architecture 200, including the CUs 210, the DUs 230, the RUs 240, the Near-RT RICs 270, the Non-RT RICs 250, and the SMO Framework 260, may include one or more interfaces or may be coupled with one or more interfaces for receiving or transmitting signals, such as data or information, via a wired or wireless transmission medium.

In some aspects, the CU 210 may be logically split into one or more CU user plane (CU-UP) units and one or more CU control plane (CU-CP) units. A CU-UP unit may communicate bidirectionally with a CU-CP unit via an interface, such as the E1 interface when implemented in an O-RAN configuration. The CU 210 may be deployed to communicate with one or more DUs 230, as necessary, for network control and signaling. Each DU 230 may correspond to a logical unit that includes one or more base station functions to control the operation of one or more RUs 240. For example, a DU 230 may host various layers, such as an RLC layer, a MAC layer, or one or more PHY layers, such as one or more high PHY layers or one or more low PHY layers. Each layer (which also may be referred to as a module) may be implemented with an interface for communicating signals with other layers (and modules) hosted by the DU 230, or for communicating signals with the control functions hosted by the CU 210. Each RU 240 may implement lower layer functionality. In some aspects, real-time and non-real-time aspects of control and user plane communication with the RU(s) 240 may be controlled by the corresponding DU 230.

The SMO Framework 260 may support RAN deployment and provisioning of non-virtualized and virtualized network elements. For non-virtualized network elements, the SMO Framework 260 may support the deployment of dedicated physical resources for RAN coverage requirements, which may be managed via an operations and maintenance interface, such as an O1 interface. For virtualized network elements, the SMO Framework 260 may interact with a cloud computing platform (such as an open cloud (O-Cloud) platform 290) to perform network element life cycle management (such as to instantiate virtualized network elements) via a cloud computing platform interface, such as an O2 interface. A virtualized network element may include, but is not limited to, a CU 210, a DU 230, an RU 240, a non-RT RIC 250, and/or a Near-RT RIC 270. In some aspects, the SMO Framework 260 may communicate with a hardware aspect of a 4G RAN, a 5G NR RAN, and/or a 6G RAN, such as an open eNB (O-eNB) 280, via an O1 interface. Additionally or alternatively, the SMO Framework 260 may communicate directly with each of one or more RUs 240 via a respective O1 interface. In some deployments, this configuration can enable each DU 230 and the CU 210 to be implemented in a cloud-based RAN architecture, such as a vRAN architecture.

The Non-RT RIC 250 may include or may implement a logical function that enables non-real-time control and optimization of RAN elements and resources, AI/ML workflows including model training and updates, and/or policy-based guidance of applications and/or features in the Near-RT RIC 270. The Non-RT RIC 250 may be coupled to or may communicate with (such as via an A1 interface) the Near-RT RIC 270. The Near-RT RIC 270 may include or may implement a logical function that enables near-real-time control and optimization of RAN elements and resources via data collection and actions via an interface (such as via an E2 interface) connecting one or more CUs 210, one or more DUs 230, and/or an O-eNB 280 with the Near-RT RIC 270.

In some aspects, to generate AI/ML models to be deployed in the Near-RT RIC 270, the Non-RT RIC 250 may receive parameters or external enrichment information from external servers. Such information may be utilized by the Near-RT RIC 270 and may be received at the SMO Framework 260 or the Non-RT RIC 250 from non-network data sources or from network functions. In some examples, the Non-RT RIC 250 or the Near-RT RIC 270 may tune RAN behavior or performance. For example, the Non-RT RIC 250 may monitor long-term trends and patterns for performance and may employ AI/ML models to perform corrective actions via the SMO Framework 260 (such as reconfiguration via an O1 interface) or via creation of RAN management policies (such as A1 interface policies).

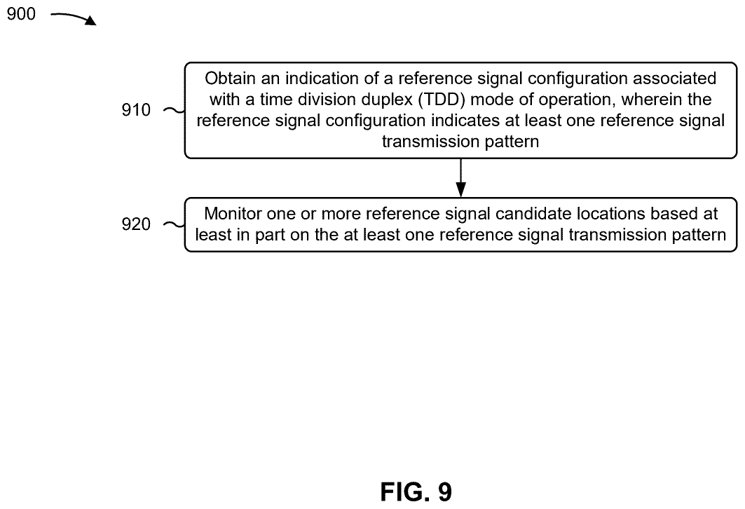

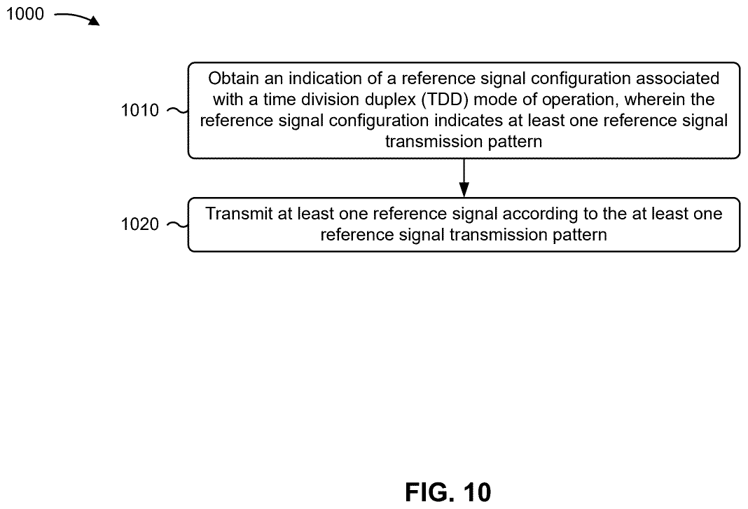

The network node 110, the processing system 145 of the network node 110, the UE 120, the processing system 140 of the UE 120, the CU 210, the DU 230, the RU 240, or any other component(s) of FIG. 1 and/or FIG. 2 may implement one or more techniques or perform one or more operations associated with availability of signals in a TDD mode of operation, as described in more detail elsewhere herein. For example, the processing system 145 of the network node 110, the processing system 140 of the UE 120, the CU 210, the DU 230, or the RU 240 may perform or direct operations of, for example, process 900 of FIG. 9, process 1000 of FIG. 10, or other processes as described herein (alone or in conjunction with one or more other processors). Memory of the network node 110 may store data and program code (or instructions) for the network node 110, the CU 210, the DU 230, or the RU 240. In some examples, the memory of the network node 110 may store data relating to a UE 120, such as RRC state information or a UE context. Memory of a UE 120 may store data and program code (or instructions) for the UE 120, such as context information. In some examples, the memory of the UE 120 or the memory of the network node 110 may include a non-transitory computer-readable medium storing a set of instructions for wireless communication. For example, the set of instructions, when executed by one or more processors (for example, of the processing system 145 or the processing system 140) of the network node 110, the UE 120, the CU 210, the DU 230, or the RU 240, may cause the one or more processors to perform process 900 of FIG. 9, process 1000 of FIG. 10, or other processes as described herein. In some examples, executing instructions may include running the instructions, converting the instructions, compiling the instructions, and/or interpreting the instructions, among other examples.

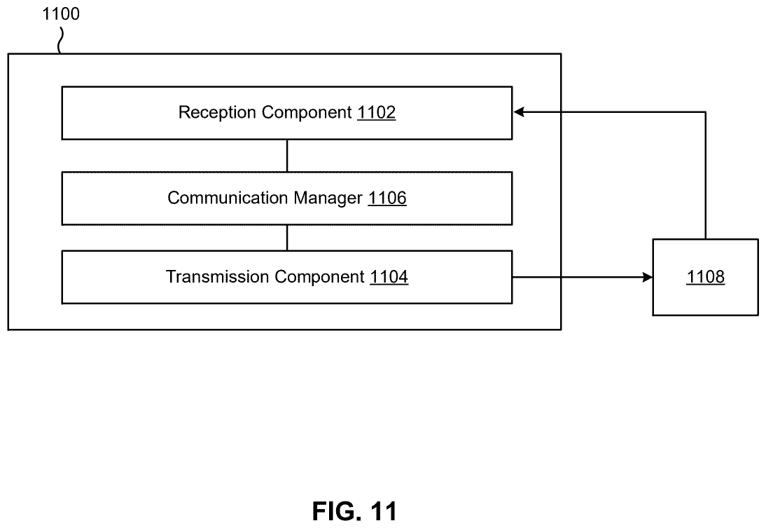

In some aspects, the UE 120 includes means for obtaining an indication of a reference signal configuration associated with a TDD mode of operation, wherein the reference signal configuration indicates at least one reference signal transmission pattern; and/or means for monitoring one or more reference signal candidate locations based at least in part on the at least one reference signal transmission pattern. The means for the UE 120 to perform operations described herein may include, for example, one or more of communication manager 150, processing system 140, a radio, one or more RF chains, one or more transceivers, one or more antennas, one or more modems, a reception component (for example, reception component 1102 depicted and described in connection with FIG. 11), and/or a transmission component (for example, transmission component 1104 depicted and described in connection with FIG. 11), among other examples.

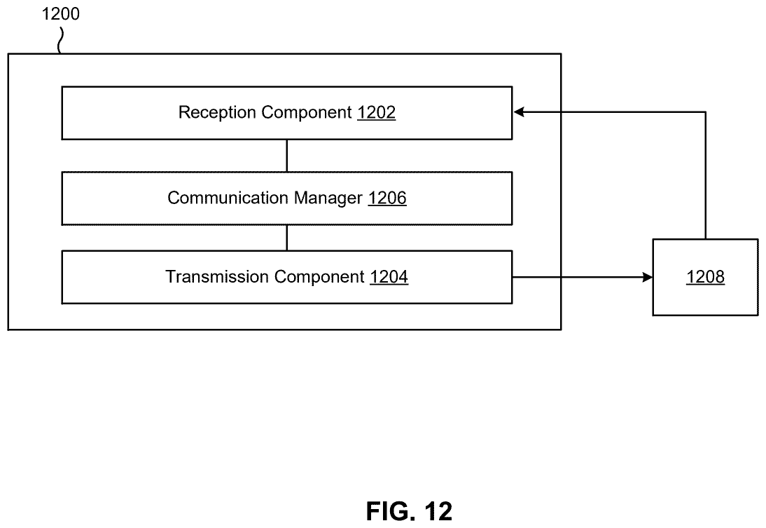

In some aspects, the network node 110 includes means for obtaining an indication of a reference signal configuration associated with a TDD mode of operation, wherein the reference signal configuration indicates at least one reference signal transmission pattern; and/or means for transmitting at least one reference signal according to the at least one reference signal transmission pattern. The means for the network node 110 to perform operations described herein may include, for example, one or more of communication manager 155, processing system 145, a radio, one or more RF chains, one or more transceivers, one or more antennas, one or more modems, a reception component (for example, reception component 1202 depicted and described in connection with FIG. 12), and/or a transmission component (for example, transmission component 1204 depicted and described in connection with FIG. 12), among other examples.

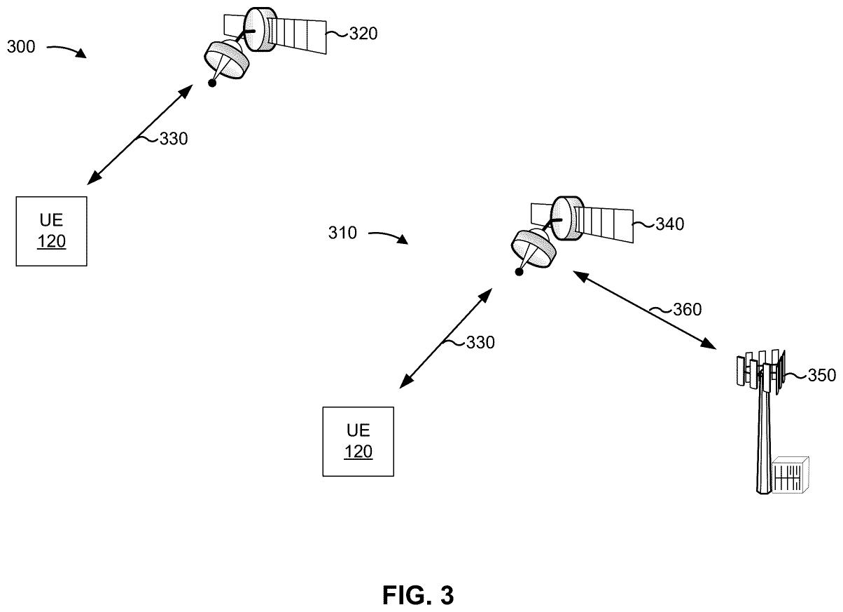

FIG. 3 is a diagram illustrating an example 300 of a regenerative satellite deployment and an example 310 of a transparent satellite deployment in a non-terrestrial network.

Example 300 shows a regenerative satellite deployment. In example 300, a UE 120 is served by a satellite 320 via a service link 330. For example, the satellite 320 may include a network node 110 (e.g., network node 110a) or a gNB. In some aspects, the satellite 320 may be referred to as a non-terrestrial base station, a regenerative repeater, or an on-board processing repeater. In some aspects, the satellite 320 may demodulate an uplink radio frequency signal, and may modulate a baseband signal derived from the uplink radio signal to produce a downlink radio frequency transmission. The satellite 320 may transmit the downlink radio frequency signal on the service link 330. The satellite 320 may provide a cell that covers the UE 120.

Example 310 shows a transparent satellite deployment, which may also be referred to as a bent-pipe satellite deployment. In example 310, a UE 120 is served by a satellite 340 via the service link 330. The satellite 340 may be a transparent satellite. The satellite 340 may relay a signal received from gateway 350 via a feeder link 360. For example, the satellite may receive an uplink radio frequency transmission, and may transmit a downlink radio frequency transmission without demodulating the uplink radio frequency transmission. In some aspects, the satellite may frequency convert the uplink radio frequency transmission received on the service link 330 to a frequency of the uplink radio frequency transmission on the feeder link 360, and may amplify and/or filter the uplink radio frequency transmission. In some aspects, the UEs 120 shown in example 300 and example 310 may be associated with a GNSS capability or a Global Positioning System (GPS) capability, though not all UEs have such capabilities. The satellite 340 may provide a cell that covers the UE 120.

The service link 330 may include a link between the satellite 340 and the UE 120, and may include one or more of an uplink or a downlink. The feeder link 360 may include a link between the satellite 340 and the gateway 350, and may include one or more of an uplink (e.g., from the UE 120 to the gateway 350) or a downlink (e.g., from the gateway 350 to the UE 120). An uplink of the service link 330 may be indicated by reference number 330-U (not shown in FIG. 3) and a downlink of the service link 330 may be indicated by reference number 330-D (not shown in FIG. 3). In some examples, the downlink 330-D may be used to transmit reference signals used for channel estimation. In some examples, the uplink 330-U and the downlink 330-D may be used to facilitate NB-IoT communications between one or more UEs 120 and the satellite 320 (e.g., an NTN network node 110).

Similarly, an uplink of the feeder link 360 may be indicated by reference number 360-U (not shown in FIG. 3) and a downlink of the feeder link 360 may be indicated by reference number 360-D (not shown in FIG. 3).

The feeder link 360 and the service link 330 may each experience Doppler effects due to the movement of the satellites 320 and 340, and potentially movement of a UE 120. These Doppler effects may be significantly larger than in a terrestrial network. The Doppler effect on the feeder link 360 may be compensated for to some degree, but may still be associated with some amount of uncompensated frequency error. Furthermore, the gateway 350 may be associated with a residual frequency error, and/or the satellite 320/340 may be associated with an on-board frequency error. These sources of frequency error may cause a received downlink frequency at the UE 120 to drift from a target downlink frequency.

As indicated above, FIG. 3 is provided as an example. Other examples may differ from what is described with regard to FIG. 3.

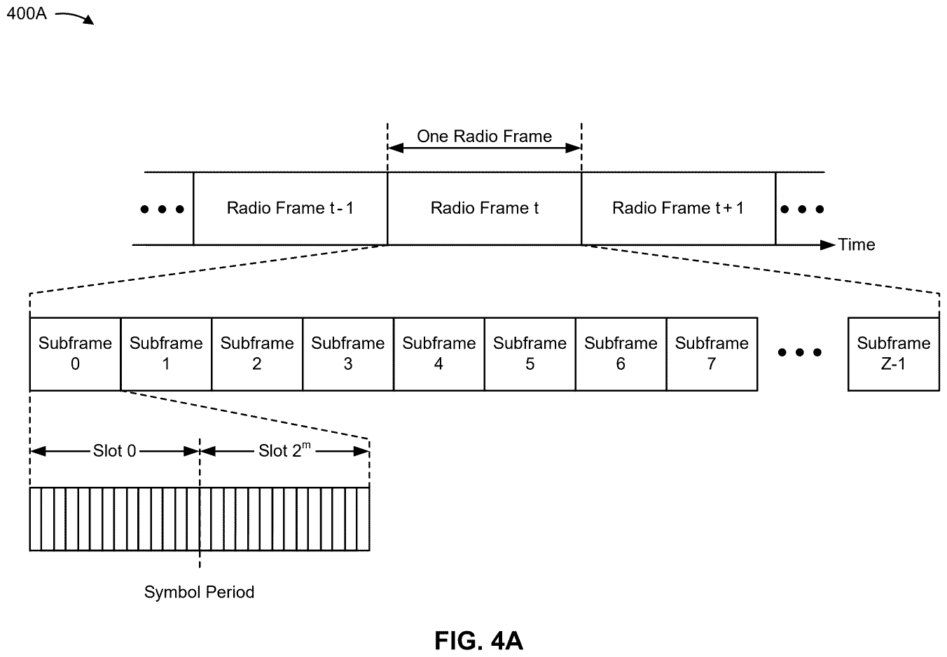

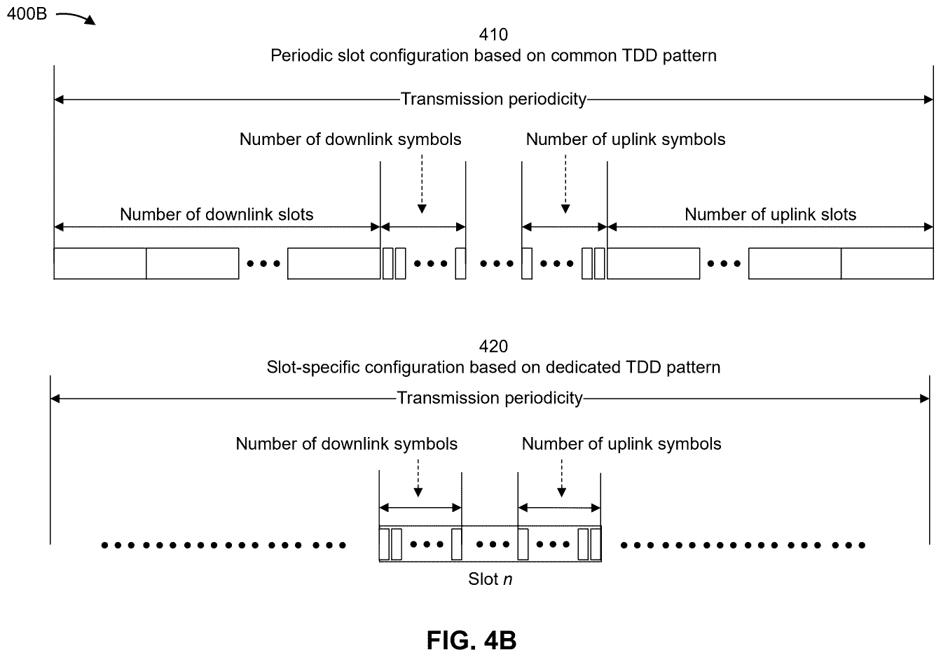

FIG. 4A is a diagram illustrating an example 400A of a frame structure in a wireless communication network, and FIG. 4B is a diagram illustrating examples 400B of slot configurations based on a TDD pattern, in accordance with the present disclosure. As shown in FIG. 4A, the frame structure is associated with a transmission timeline that may be partitioned into units of radio frames (sometimes referred to as frames). In a TDD configuration, the frame structure may be configured with a certain ratio of UL or DL transmission frames relative to the total number of frames, and there may be an offset distance between sequential UL frames and DL frames. Alternatively, in a frequency division duplexing (FDD) configuration, separate frame structures may be configured in different frequencies for each of the uplink and the downlink. Each radio frame may have a predetermined duration (e.g., 10 ms) and may be partitioned into a set of Z (Z≥1) subframes (e.g., with indices of 0 through Z-1). Each subframe may have a predetermined duration (e.g., 1 ms) and may include a set of slots (e.g., 2m slots per subframe are shown in FIG. 4A, where m is an index of a numerology used for a transmission, such as 0, 1, 2, 3, 4, or another number). Each slot may include a set of L symbol periods. For example, each slot may include fourteen symbol periods (e.g., as shown in FIG. 4A), seven symbol periods, or another number of symbol periods. In a case where the subframe includes two slots (e.g., when m=1), the subframe may include 2L symbol periods, where the 2L symbol periods in each subframe may be assigned indices of 0 through 2L-1. In some aspects, a scheduling unit may be frame-based, subframe-based, slot-based, mini-slot based, or symbol-based.

As shown in FIG. 4B, and by reference number 410, a TDD configuration may be associated with a periodic slot configuration based on one or more common TDD patterns that a network node configures using cell-specific signaling. For example, as shown by reference number 410, a TDD-UL-DL-ConfigurationCommon parameter may indicate one or more common TDD patterns to be used in a cell associated with a network node, where each common TDD pattern includes a transmission periodicity (e.g., a periodicity of the common TDD pattern), a number of consecutive full downlink slots at the start of each common TDD pattern, a number of consecutive downlink symbols that follow the last full downlink slot, a number of consecutive full uplink slots at the end of each common TDD pattern, and a number of consecutive uplink symbols that precede the first full uplink slot. In general, the slot configuration may include one or more flexible symbols (usable for downlink or uplink communication) between the last downlink symbol and the first uplink symbol, and the slots that encompass the flexible symbols, the consecutive downlink symbols that follow the last full downlink slot, and the consecutive uplink symbols that precede the first full uplink slot may be defined as flexible slots.

As further shown by reference number 420, the network node may configure all or part of the flexible slots and/or symbols using a dedicated TDD pattern (e.g., using UE-specific or group-common signaling). For example, a dedicated TDD pattern may be defined using a TDD-UL-DL-ConfigDedicated parameter, which indicates a slot index (e.g., a slot within a particular common TDD pattern) and one or more parameters to allocate symbols in the slot associated with the slot index to downlink or uplink communication. For example, the dedicated TDD pattern may indicate that all symbols in the indicated slot are allocated to downlink communication, may indicate that all symbols in the indicated slot are allocated to uplink communication, or may indicate a number of consecutive symbols in the beginning of the slot that are allocated to downlink communication and/or a number of consecutive symbols at the end of the slot that are allocated to uplink communication.

In some cases, the network node may indicate the slot configuration to be used in a cell associated with the network node via a common TDD pattern and/or may indicate a slot configuration to be used by one or more UEs served by the network node via a dedicated TDD pattern that configures (or reconfigures) one or more flexible slots or symbols associated with the common TDD pattern. Additionally, or alternatively, the network node may transmit a slot format indicator (SFI) to indicate a slot configuration that allocates symbols within a slot to be downlink symbols, uplink symbols, or flexible symbols. For example, the SFI may be transmitted in a DCI message that has a specific format associated with indicating a slot format (e.g., DCI format 2_0), and the network node may configure a served UE with a SlotFormatCombination parameter that causes the UE to monitor the DCI associated with indicating the slot format. In such cases, the DCI message may include an SFI, which may have a value within a particular range (e.g., from 0 to 255) to indicate an allocation of downlink, uplink, and flexible symbols within a particular slot (e.g., as defined in one or more wireless communication standards). Accordingly, a UE may determine the specific slot configuration allocating transmission time intervals (TTIs) to downlink and/or uplink communication based on a combination of the common TDD pattern, the dedicated TDD pattern, and the SFI. Furthermore, in cases where full-duplex communication is enabled in a particular slot or symbol, the full-duplex slot(s) or symbol(s) may similarly be indicated via the common TDD pattern, the dedicated TDD pattern, and the SFI.

As indicated above, FIGS. 4A-4B are provided as examples. Other examples may differ from what is described with respect to FIGS. 4A-4B.

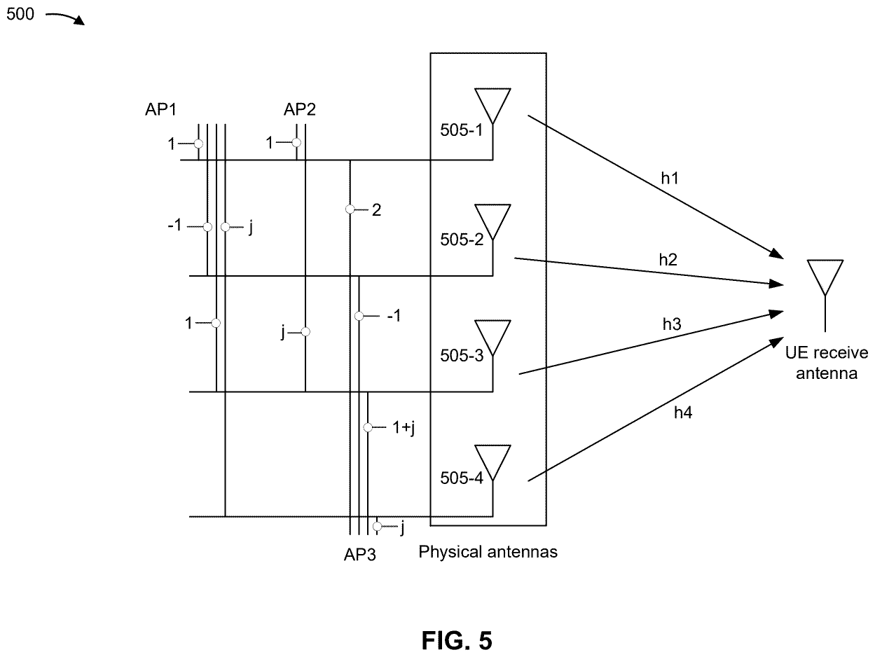

FIG. 5 is a diagram illustrating an example 500 of antenna ports, in accordance with the present disclosure.

As shown in FIG. 5, a first physical antenna 505-1 may transmit information via a first channel h1, a second physical antenna 505-2 may transmit information via a second channel h2, a third physical antenna 505-3 may transmit information via a third channel h3, and a fourth physical antenna 505-4 may transmit information via a fourth channel h4. Such information may be conveyed via a logical antenna port, which may represent some combination of the physical antennas and/or channels. In some cases, a UE 120 may not have knowledge of the channels associated with the physical antennas, and may only operate based on knowledge of the channels associated with antenna ports, as defined below. For example, a UE 120 may operate based on knowledge of the signal types that may be transmitted on the same or on different antenna ports. Similarly, in some examples, a wireless network may enable signal mapping configurations such that a signal may be transmitted on one or more antenna ports.

An antenna port may be defined such that a channel, over which a symbol on the antenna port is conveyed, can be inferred from a channel over which another symbol on the same antenna port is conveyed. In example 500, a channel associated with antenna port 1 (AP1) is represented as h1−h2+h3+j*h4, where channel coefficients (e.g., 1, −1, 1, and j, in this case) represent weighting factors (e.g., indicating phase and/or gain) applied to each channel. Such weighting factors may be applied to the channels to improve signal power and/or signal quality at one or more receivers. Applying such weighting factors to channel transmissions may be referred to as precoding, and a precoder may refer to a specific set of weighting factors applied to a set of channels.

Similarly, a channel associated with antenna port 2 (AP2) is represented as h1+j*h3, and a channel associated with antenna port 3 (AP3) is represented as 2*h1−h2+(1+j)*h3+j*h4. In this case, antenna port 3 can be represented as the sum of antenna port 1 and antenna port 2 (e.g., AP3=AP1+AP2) because the sum of the expression representing antenna port 1 (h1−h2+h3+j*h4) and the expression representing antenna port 2 (h1+j*h3) equals the expression representing antenna port 3 (2*h1−h2+(1+j)*h3+j*h4). It can also be said that antenna port 3 is related to antenna ports 1 and 2 [AP1,AP2] via the precoder [1,1] because 1 times the expression representing antenna port 1 plus 1 times the expression representing antenna port 2 equals the expression representing antenna port 3.

As indicated above, FIG. 5 is provided merely as an example. Other examples may differ from what is described with regard to FIG. 5.

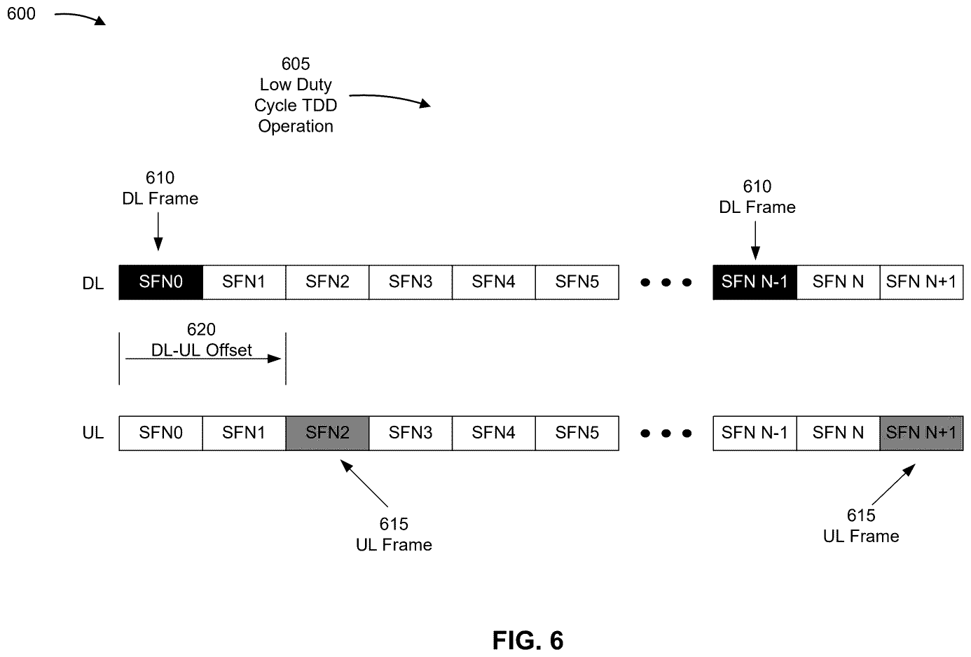

FIG. 6 is a diagram illustrating an example 600 of a low duty cycle TDD operation, in accordance with the present disclosure.

As shown by reference number 605, a low duty cycle TDD operation may include a DL transmission timeline and an UL transmission timeline, where each timeline includes a number of radio frames used for DL transmissions and UL transmissions, respectively. For example, the DL transmission timeline may include DL frames 610 numbered as system frame number (SFN) 0 through SFN-N+1, and the UL transmission timeline may include UL frames 615 numbered as SFN0 through SFN N+1.

In some examples, each DL frame 610 may be offset in time from an UL frame 615 by a DL-UL offset 620. For example, FIG. 6 depicts a DL-UL offset 620 including two radio frames between the beginning of a DL frame 610 and the beginning of an UL frame 615. In some examples, a low duty cycle TDD operation may include a low ratio of time (e.g., frames) dedicated to active transmission relative to total time (e.g., number of radio frames) in a period. For example, a low duty cycle TDD operation may include x out of N radio frames used for UL transmission (e.g., where x is 1 and N is 10) and y out of N radio frames used for DL transmission (e.g., where y is 1 and N is 10), where x and y may have the same value or different values and where the UL transmission frames may be offset from the DL transmission frames. In some examples, a low duty cycle TDD operation may include devices operating in an active state for a relatively small percentage of time and operating in an in active state for a relatively larger percentage of time. For example, in a low duty cycle TDD operation, the number of frames available for DL transmission may satisfy a threshold (e.g., less than ten percent) relative to the total frames in a frame timeline.

In some examples, a low duty cycle TDD mode in an NB-IoT NTN operation may include a limited availability of DL resources (e.g., available DL frames 610), resulting in decreased downlink performance (e.g., demodulation of DL transmissions) due to a reduced opportunity for channel estimation. For example, because there are fewer DL resources available in a low duty cycle TDD mode, there are infrequent opportunities for a UE to receive reference signals in a DL frame 610 in order to perform channel estimation. As a result, channel estimation may be unsuccessful (or less efficient) and the decoding and demodulation of DL transmissions (e.g., data packets) may be postponed to a next duty cycle. For example, in a low duty cycle TDD operation, a UE may postpose decoding and demodulation of DL transmissions for multiple duty cycles (e.g., that may be 90 ms apart in a configuration where there are 9 frames between successive DL frames), which may increase communication latency. Accordingly, more frequently available DL resources may improve downlink performance by enabling a UE to receive reference signals more frequently in order to improve channel estimation and permit decoding and/or demodulation of received messages. For example, a UE may utilize more frequently transmitted reference signals to enable more accurate channel estimation, thereby enabling the UE to adapt communication strategies (e.g., adjust decoding/encoding schemes, adjust transmission power, or the like) to changing network conditions. Additionally, more frequent opportunities for channel estimation may enable network adaptation of downlink parameters and/or uplink parameters.

As indicated above, FIG. 6 is provided as an example. Other examples may differ from what is described with respect to FIG. 6.

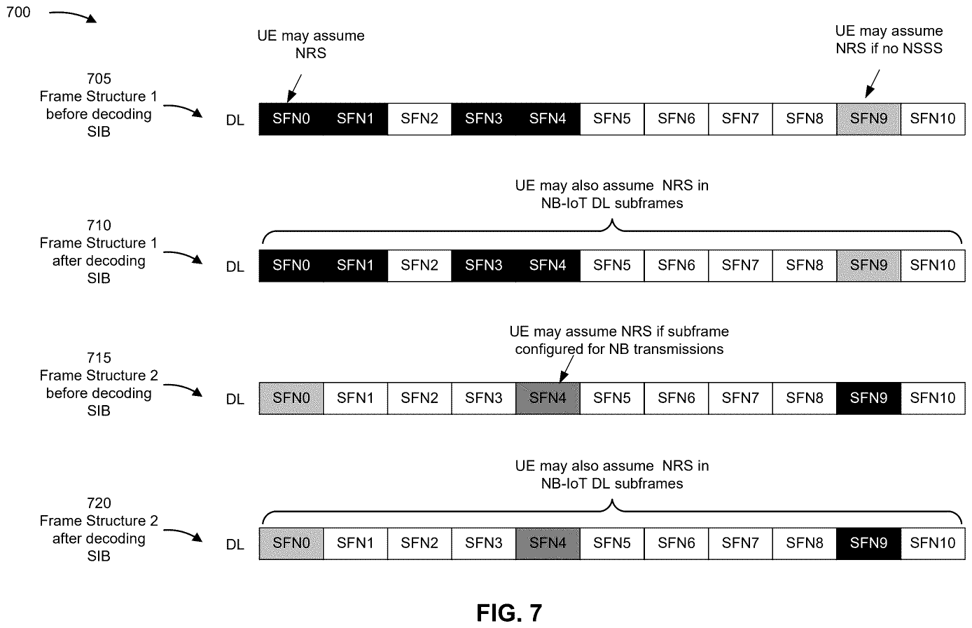

FIG. 7 is a diagram illustrating an example 700 of NRS availability, in accordance with the present disclosure. In some examples, on an NB-IoT carrier in which a UE 120 receives a higher-layer (e.g., RRC) parameter operationModeInfo indicating guardband or standalone operation mode, the UE 120 may receive a configuration enabling the UE 120 to assume that a DL frame includes one or more NRS transmissions, depending on the current frame structure and whether the UE 120 has decoded a SIB (e.g., SystemInformationBlockType1-NB).

In some examples, the assumptions on NRS availability depend on whether the SIB has been decoded by the UE 120 because the SIB may indicate a valid DL subframe bitmap that may potentially restrict almost all subframes from being NB-IoT DL subframes. As a result, prior to SIB decoding, the UE 120 may assume a limited availability of NRSs that will not be rendered invalid by a DL subframe bitmap received in a SIB.

For example, as shown by reference number 705, where a UE 120 is operating in a frame structure type 1 and the UE 120 has not decoded the SIB, the UE 120 may assume that NRSs are transmitted in subframes #0, #1, #3, and #4 and in subframes #9 not containing an NSSS.

As further shown by reference number 710, where a UE 120 is operating in a frame structure type 1 and the UE 120 has decoded the SIB, the UE 120 may assume that NRSs are transmitted in subframes #0, #1, #3, and #4, in subframes #9 not containing NSSS, and in NB-IoT DL subframes indicated by the DL subframe bitmap in the decoded SIB.

Similarly, as shown by reference number 715, where a UE 120 is operating in a frame structure type 2 and the UE 120 has not decoded the SIB, the UE 120 may assume that NRSs are transmitted in subframes #9, in subframes #0 not containing NSSS, and in subframes #4 if subframes #4 are configured for SystemInformationBlockType1-NB transmissions.

As further shown by reference number 720, where a UE 120 is operating in a frame structure type 2 and the UE 120 has decoded the SIB, the UE 120 may assume that NRSs are transmitted in subframes #9, in subframes #0 not containing NSSS, in subframes #4 if subframes #4 are configured for SystemInformationBlockType1-NB transmissions, and in NB-IoT DL subframes indicated by the DL subframe bitmap in the decoded SIB.

Because the UE assumptions on NRS availability are dependent upon whether the UE has decoded the SIB, one or more NRS availability patterns may apply prior to when the UE 120 has decoded the SIB and a different one or more NRS availability patterns may apply after the UE 120 decodes the SIB. This configuration may enable the UE to adapt its monitoring of reference signal candidate locations according to a currently applicable NRS availability pattern, thereby increasing the efficiency of monitoring for reference signals.

As indicated above, FIG. 7 is provided as an example. Other examples may differ from what is described with respect to FIG. 7.

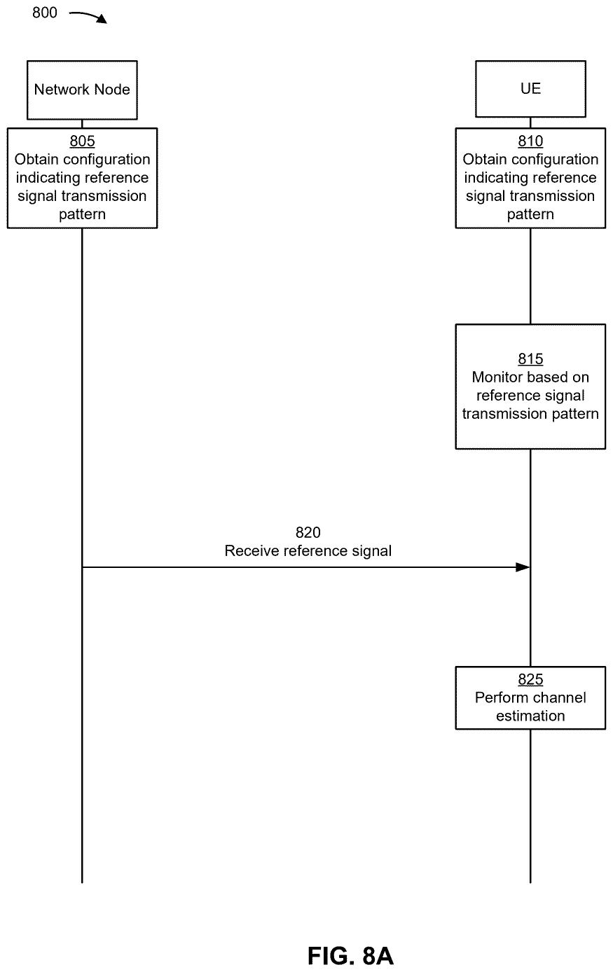

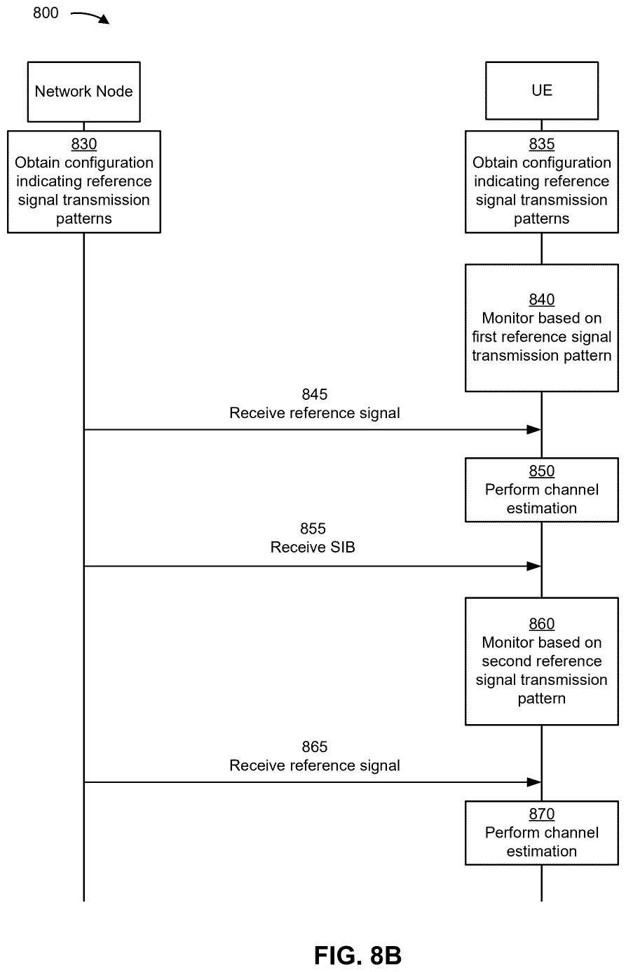

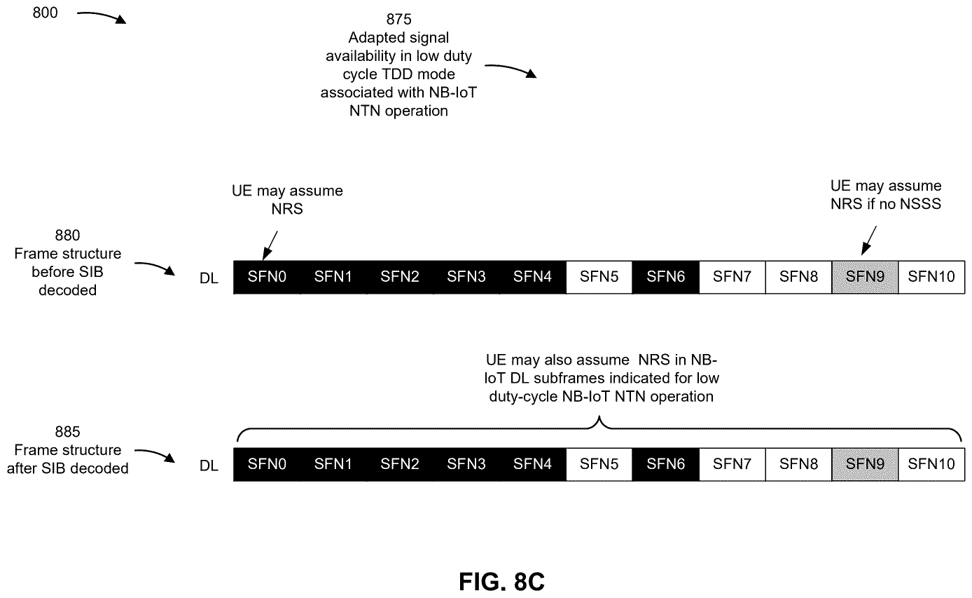

FIGS. 8A-8C are diagrams of examples 800 associated with availability of signals in a TDD mode of operation, in accordance with the present disclosure. As shown in FIGS. 8A-8C, a network node (e.g., network node 110) may communicate with a UE (e.g., UE 120). In some aspects, the network node and the UE may be part of a wireless network (e.g., wireless network 100). For example, the network node and the UE may be associated with an NB-IoT NTN operation, and the network node and the UE may utilize an NB-IoT frame structure. In some aspects, actions described as being performed by the network node may be performed by multiple different network nodes. For example, configuration actions may be performed by a first network node (e.g., a CU and/or a DU), and radio communication actions may be performed by a second network node (e.g., a DU and/or an RU). The UE and the network node may have established a wireless connection prior to operations shown in FIGS. 8A-8C.

For example, as shown by reference number 805 of FIG. 8A, the network node may obtain configuration information indicating a reference signal (e.g., an NRS) transmission pattern for a low duty cycle TDD mode. In some aspects, the configuration information may include an indication of one or more configuration parameters (e.g., already known to the network node, stored in the memory storage of the network node, and/or previously indicated by the wireless network or by other network device) for selection by the network node, and/or explicit configuration information for the network node to use to configure the network node, among other examples. In some aspects, the configuration information may be based on a reference signal pattern defined in a wireless communication standard.

In some aspects, the configuration information may indicate that the network node is to transmit reference signals based at least in part on at least one reference signal transmission pattern. The network node may configure itself based at least in part on the configuration information. In some aspects, the network node may be configured to perform one or more operations described herein based at least in part on the configuration information.

As shown by reference number 810, the UE may obtain configuration information indicating a reference signal (e.g., an NRS) transmission pattern for a low duty cycle TDD mode. In some aspects, the configuration information may include an indication of one or more configuration parameters (e.g., already known to the UE, stored in the memory storage of the UE, and/or previously indicated by the wireless network, a network node, or other network device) for selection by the UE, and/or explicit configuration information for the UE to use to configure the network node, among other examples. In some aspects, the configuration information may be based on a reference signal pattern defined in a wireless communication standard.

In some aspects, the configuration information may indicate that the UE is to monitor one or more reference signal candidate locations based at least in part on at least one reference signal transmission pattern. The UE may configure itself based at least in part on the configuration information. In some aspects, the UE may be configured to perform one or more operations described herein based at least in part on the configuration information.

As shown by reference number 815, the UE may monitor one or more reference signal candidate locations based at least in part on at least one reference signal transmission pattern indicated by the configuration information obtained by the UE. For example, the UE may monitor the one or more reference signal candidate locations for the receipt of DL transmissions from the network node that include a reference signal (e.g., an NRS). In some aspects, the UE may utilize the received reference signal to perform channel estimation in order to improve the demodulation and decoding of DL transmissions received at the UE, thereby reducing errors.

In some aspects, the TDD mode of operation may be associated with one or more frequency bands. For example, the TDD mode of operation may be associated with frequency bands that correspond to one or more wireless network operators and/or carriers. Additionally, or alternatively, the UE may be able to identify a wireless network operator and/or carrier based at least in part on a reference signal pattern (e.g., a reference signal transmission pattern). In some aspects, the TDD mode of operation may be associated with a DL-UL frame structure. For example, the DL-UL frame structure may be associated with a frequency band and/or with one or more wireless network operators and/or carriers. Accordingly, the UE (and/or the network node) may be able to identify a TDD mode of operation based at least in part on a known wireless network operator and/or carrier, thereby enabling the UE to utilize one or more specific reference signal transmission patterns and/or other signal configurations (e.g., associated with an NPSS, NSSS, and/or NPBCH) where the UE is aware of a current wireless network operator and/or carrier. Additionally, or alternatively, the UE may be able to identify a wireless network operator and/or carrier based at least in part on a reference signal pattern (e.g., a reference signal transmission pattern) and/or other signal configurations (e.g., associated with an NPSS, NSSS, and/or NPBCH).

In some aspects, the low duty cycle TDD mode may be associated with an NB-IoT NTN operation. For example, an NB-IoT DL subframe structure may be indicated via a valid DL subframe bitmap in a SIB that is specific to a low duty cycle TDD mode of NB-IoT NTN operation. For example, in the relevant frequency bands, all TDD DL subframes (e.g., of corresponding radio frames) may be NB-IoT DL subframes. Additionally, or alternatively, in the relevant frequency bands, all non-TDD DL subframes may not be NB-IoT DL subframes. As a result, this specificity may enable a wireless network to utilize an increased number of DL subframes for NRS transmission, and may enable the UE to accurately assume the DL subframes associated with NRS transmission.

As shown by reference number 820, the network node may transmit (directly or via one or more other network nodes), and the UE may receive, a reference signal. In some aspects, the reference signal may be transmitted based at least in part on at least one reference signal transmission pattern. For example, the reference signal may be transmitted in one or more of the reference signal candidate locations monitored by the UE based at least in part on at least one reference signal transmission pattern.

As shown by reference number 825, the UE may perform channel estimation on the reference signal received in connection with reference number 820, enabling more accurate demodulation and decoding of DL transmissions received from the network node. For example, where the availability of DL resources for reference signals is adapted to a low duty cycle TDD mode associated with an NB-IoT NTN operation, channel estimation results may be improved due to an increased frequency of reference signal occasions available for channel estimation. As a result of the improved channel estimation results, the UE may adapt to channel and/or network conditions to enable more accurate decoding and demodulation of transmissions received from the network node. Additionally, the network node may adapt to channel and/or network conditions based on the UE providing a CSI report and/or CSI feedback.

Additionally, or alternatively, as shown by reference number 830 of FIG. 8B, the network node may obtain configuration information indicating a quantity of reference signal (e.g., an NRS) transmission patterns for a low duty cycle TDD mode. In some aspects, the configuration information may include an indication of one or more configuration parameters (e.g., already known to the network node, stored in the memory storage of the network node, and/or previously indicated by the wireless network or by other network device) for selection by the network node, and/or explicit configuration information for the network node to use to configure the network node, among other examples.

In some aspects, the configuration information may indicate that the network node is to transmit reference signals based at least in part on at least one reference signal transmission pattern. In some aspects, the configuration information may indicate a first reference signal transmission pattern associated with a first set of reference signal candidate locations and a second reference signal transmission pattern associated with a second set of reference signal candidate locations. For example, the first reference signal transmission pattern may be utilized by a UE prior to decoding a SIB, and the second reference signal transmission pattern may be utilized by the UE after decoding the SIB. The network node may configure itself based at least in part on the configuration information. In some aspects, the network node may be configured to perform one or more operations described herein based at least in part on the configuration information.

As shown by reference number 835, the UE may obtain configuration information indicating a quantity of reference signal (e.g., an NRS) transmission patterns for a low duty cycle TDD mode. In some aspects, the configuration information may include an indication of one or more configuration parameters (e.g., already known to the UE, stored in the memory storage of the UE, and/or previously indicated by the wireless network, a network node, or other network device) for selection by the UE, and/or explicit configuration information for the UE to use to configure the network node, among other examples.

In some aspects, the configuration information may indicate that the UE is to monitor one or more reference signal candidate locations based at least in part on at least one reference signal transmission pattern. In some aspects, the configuration information may indicate a first reference signal transmission pattern associated with a first set of reference signal candidate locations and a second reference signal transmission pattern associated with a second set of reference signal candidate locations. For example, the UE may utilize the first reference signal transmission pattern prior to decoding a SIB from the network node, and the UE may utilize the second reference signal transmission pattern after decoding the SIB from the network node. In some aspects, the UE may utilize the first reference signal transmission pattern based on an assumption of a DL-UL (sub)frame structure associated with the SIB not yet being decoded. In some aspects, the UE may utilize the second reference signal transmission pattern based on an assumption of a different DL-UL (sub)frame structure than the DL-UL (sub)frame structure associated with the first reference signal transmission pattern (e.g., after decoding of the SIB). The UE may configure itself based at least in part on the configuration information. In some aspects, the UE may be configured to perform one or more operations described herein based at least in part on the configuration information.

As shown by reference number 840, prior to decoding the SIB from the network node, the UE may monitor a first set of reference signal candidate locations based at least in part on the first reference signal transmission pattern indicated by the configuration information obtained by the UE. For example, the UE may monitor the first set of reference signal candidate locations for the receipt of DL transmissions from the network node that include a reference signal (e.g., an NRS). In some aspects, the UE may utilize the received reference signal to perform channel estimation in order to improve the demodulation and decoding of DL transmissions received at the UE, thereby reducing downlink decoding errors.

As shown by reference number 845, the network node may transmit (directly or via one or more other network nodes), and the UE may receive, a reference signal. In some aspects, the reference signal may be transmitted based at least in part on the first reference signal transmission pattern. For example, the reference signal may be transmitted in one or more of the reference signal candidate locations of the first set of reference signal candidate locations monitored by the UE based at least in part on the first reference signal transmission pattern.

As shown by reference number 850, the UE may perform channel estimation on the reference signal received in connection with reference number 845, enabling more accurate demodulation and decoding of DL transmissions received from the network node. For example, the UE may monitor the first set of reference signal candidate locations for the receipt of DL transmissions from the network node that include a reference signal (e.g., an NRS). In some aspects, the UE may utilize the received reference signal to perform channel estimation in order to improve the demodulation and decoding of DL transmissions received at the UE, thereby reducing errors.

As shown by reference number 855, the network may transmit (directly or via one or more other network nodes), and the UE may receive, a SIB. In some aspects, the SIB may include a DL subframe bitmap that may restrict a quantity of subframes from being utilized as NB-IoT DL subframes.

As shown by reference number 860, after decoding the SIB from the network node, the UE may monitor a second set of reference signal candidate locations based at least in part on the second reference signal transmission pattern indicated by the configuration information obtained by the UE. For example, the UE may monitor the second set of reference signal candidate locations for the receipt of DL transmissions from the network node that include a reference signal (e.g., an NRS). In some aspects, the UE may utilize the received reference signal to perform channel estimation in order to improve the demodulation and decoding of DL transmission received at the UE, thereby reducing downlink decoding errors.

As shown by reference number 865, the network node may transmit (directly or via one or more other network nodes), and the UE may receive, a reference signal. In some aspects, the reference signal may be transmitted based at least in part on the second reference signal transmission pattern. For example, the reference signal may be transmitted in one or more of the reference signal candidate locations of the second set of reference signal candidate locations monitored by the UE based at least in part on the second reference signal transmission pattern.

As shown by reference number 870, the UE may perform channel estimation on the reference signal received in connection with reference number 865, enabling more accurate demodulation and decoding of DL transmissions received from the network node. For example, the UE may monitor the second set of reference signal candidate locations for the receipt of DL transmissions from the network node that include a reference signal (e.g., an NRS). In some aspects the UE may utilize the received reference signal to perform channel estimation in order to improve the demodulation and decoding of DL transmissions received at the UE, thereby reducing downlink decoding errors.

In some aspects, the configuration information obtained by the network node and the configuration information obtained by the UE may indicate DL resource availability for reference signals (e.g., NRSs) associated with one or more anchor carriers and for reference signals associated with one or more non-anchor carriers. For example, the configuration information may indicate a first reference signal transmission pattern associated with an anchor carrier and a first set of reference signal candidate locations. Additionally, the configuration information may indicate a second reference signal transmission pattern associated with a non-anchor carrier and a second set of reference signal candidate locations. By indicating different reference signal transmission patterns and accompanying reference signal candidate locations for an anchor carrier and for a non-anchor carrier, the network node and the UE may be able to flexibly adapt reference signal patterns to anchor carrier and non-anchor carrier scenarios.

As shown by reference number 875 of FIG. 8C, signal availability may be adapted in low duty cycle TDD modes, including in NB-IoT NTN operations, to improve channel estimation by improving the availability of DL resources for reference signal transmission and reception.

As shown by reference number 880, prior to the UE decoding a SIB, the frame structure may include a reference signal transmission pattern having a quantity of reference signal candidate locations that the UE may assume contain a reference signal (e.g., NRS). In some aspects, the reference signal transmission pattern may have an increased frequency of reference signal candidate locations relative to the low duty cycle TDD mode frame pattern of FIG. 6. For example, the reference signal transmission pattern shown by reference number 880 may be associated with the first reference signal pattern of FIG. 8B.

As shown by reference number 885, after the UE decodes the SIB, the frame structure may include a different reference signal transmission pattern including reference signal candidate locations that the UE may assume contain a reference signal (e.g., NRS). For example, the reference signal transmission pattern shown by reference number 885 may be associated with the second reference signal pattern of FIG. 8B.

Additionally, or alternatively, the configuration information obtained by the network node and the configuration information obtained by the UE may indicate a frame structure associated with one or more of an NPSS, an NSSS, or an NPBCH (e.g., additional always-on signals for narrowband operation). In some aspects, the frame structure may be associated with at least one reference signal transmission pattern. In some aspects, the NPSS, NSSS, and/or NPBCH availability may be indicated as associated with a low duty cycle TDD mode of NB-IoT NTN operation (e.g., associated with one or more frequency bands and/or an NB-IoT downlink-uplink frame structure). For example, prior to decoding a SIB, the UE may assume that an NPSS, NSSS, and/or NPBCH will occur once in every DL radio frame, and that additional NPSSs, NSSSs, and or NPBCHs may be configured after decoding the SIB. As a result, where additional NPSSs, NSSSs, and/or NPBCHs may be configured, DL channel estimation may be improved. For example, and as discussed below, where NSSS may be utilized in conjunction with NRS in a single antenna port, channel estimation may be improved.

In some aspects, the UE may obtain an indication of an additional signal configuration associated with at least one of the NPSS, the NSSS, and/or the NPBCH associated with the TDD mode of operation. In some aspects, the additional signal configuration may indicate a first additional signal configuration associated with at least one of the NPSS, the NSSS, or the NPBCH (e.g., a first set of signals) and a second additional signal configuration associated with at least one of the NPSS, the NSSS, or the NPBCH (e.g., a second set of signals). In some aspects, the UE may monitor, prior to decoding the SIB, at least one of the NPSS, the NSSS, or the NPBCH (e.g., a first set of signals) based at least in part on the additional signal configuration, and the UE may monitor, after decoding the SIB, at least of the NPSS, the NSSS, or the NPBCH (e.g., a second set of signals) based at least in part on the additional signal configuration. In some aspects, the NPSS, the NSSS, or the NPBCH monitored prior to decoding the SIB (e.g., a first set of signals) may be different from the NPSS, the NSSS, or the NPBCH monitored after decoding the SIB (e.g., a second set of signals).

In some aspects, for low duty cycle TDD NB-IoT NTN operations (e.g., in one or more indicated frequency bands), the network node and the UE may obtain respective configuration information indicating that a reference signal (e.g., NRS) associated with at least one reference signal transmission pattern and an always-on signal (e.g., NPSS, NSSS, and/or NPBCH) share an antenna configuration (e.g., the reference signal and the always-on signal may be transmitted from the same antenna port). For example, the antenna configuration may be associated with a DL mode utilizing a single transmit chain (e.g., a 1Tx mode). By utilizing the single antenna port to transmit both the reference signal and the always-on signal, the UE may utilize both signals in channel estimation, thereby decreasing downlink error rates and increasing channel estimation efficiency.

In some examples described herein, the network node may be configured to transmit reference signals according to a reference signal transmission pattern associated with a low duty cycle TDD mode, and the UE may be configured to monitor reference signal candidate locations according to the reference signal transmission pattern associated with the low duty cycle TDD mode. By adapting the network node and the UE to the low duty cycle TDD mode, the availability of DL resource may be improved, thereby enabling more frequent reference signal occurrences. The increase in frequency of reference signal occasions may improve channel estimation by providing more accurate, real-time information on network conditions and the strength and/or reliability of transmissions between the network node and the UE. This information may enable the network node and the UE to adapt communications strategies (e.g., modulation schemes, interference mitigation, transmission power, or the like) in order to increase accuracy and reliability of communications.

Additionally, in some examples described herein, the UE may assume reference signal availability depending on whether a SIB has been decoded. For example, the SIB may indicate a valid DL subframe bitmap that may potentially restrict almost all subframes from being NB-IoT DL subframes, thereby affecting the availability of frames for reference signal transmission. For example, prior to SIB decoding, the UE may assume a limited availability of reference signal DL resources that may not be invalidated by a DL subframe bitmap received in a SIB. Additionally, after SIB decoding, the UE may assume a different availability of reference signal DL resources according to a DL subframe bitmap received in the SIB. Accordingly, by enabling the UE to utilize potentially different reference signal transmission patterns prior to SIB decoding and after SIB decoding, the UE may adapt assumptions to the currently available DL resources for reference signals.

As indicated above, FIGS. 8A-8C are provided as examples. Other examples may differ from what is described with respect to FIGS. 8A-8C.

FIG. 9 is a diagram illustrating an example process 900 performed, for example, at a UE or an apparatus of a UE, in accordance with the present disclosure. Example process 900 is an example where the apparatus or the UE (e.g., UE 120) performs operations associated with availability of signals in a TDD mode of operation.

As shown in FIG. 9, in some aspects, process 900 may include obtaining an indication of a reference signal configuration associated with a TDD mode of operation, wherein the reference signal configuration indicates at least one reference signal transmission pattern (block 910). For example, the UE (e.g., using reception component 1102 and/or communication manager 1106, depicted in FIG. 11) may obtain an indication of a reference signal configuration associated with a TDD mode of operation, wherein the reference signal configuration indicates at least one reference signal transmission pattern, as described above.

As further shown in FIG. 9, in some aspects, process 900 may include monitoring one or more reference signal candidate locations based at least in part on the at least one reference signal transmission pattern (block 920). For example, the UE (e.g., using communication manager 1106, depicted in FIG. 11) may monitor one or more reference signal candidate locations based at least in part on the at least one reference signal transmission pattern, as described above.

Process 900 may include additional aspects, such as any single aspect or any combination of aspects described below and/or in connection with one or more other processes described elsewhere herein.

In a first aspect, the TDD mode of operation is associated with NB IoT NTN operation.

In a second aspect, alone or in combination with the first aspect, the TDD mode of operation is associated with a NB IoT DL subframe structure that is indicated by a DL subframe bitmap, where all DL subframes, associated with the TDD mode of operation, are NB-IoT DL subframes.

In a third aspect, alone or in combination with one or more of the first and second aspects, the TDD mode of operation is associated with one or more frequency bands.

In a fourth aspect, alone or in combination with one or more of the first through third aspects, the TDD mode of operation is associated with a DL-UL frame structure.

In a fifth aspect, alone or in combination with one or more of the first through fourth aspects, monitoring the one or more reference signal candidate locations occurs prior to a decoding of a SIB.

In a sixth aspect, alone or in combination with one or more of the first through fifth aspects, monitoring the one or more reference signal candidate locations occurs after a decoding of a SIB.

In a seventh aspect, alone or in combination with one or more of the first through sixth aspects, monitoring the one or more reference signal candidate locations includes receiving a SIB, wherein the at least one reference signal transmission pattern includes a first reference signal transmission pattern associated with a first set of reference signal candidate locations and a second reference signal transmission pattern associated with a second set of reference signal candidate locations, monitoring, prior to decoding the SIB, the first set of reference signal candidate locations based at least in part on the first reference signal transmission pattern, and monitoring, after decoding the SIB, the second set of reference signal candidate locations based at least in part on the second reference signal transmission pattern.

In an eighth aspect, alone or in combination with one or more of the first through seventh aspects, the SIB includes a DL subframe bitmap indicating that the TDD mode of operation is associated with an NB-IoT DL subframe structure, and where all DL subframes, associated with the TDD mode of operation, are NB-IoT DL subframes.

In a ninth aspect, alone or in combination with one or more of the first through eighth aspects, the first reference signal transmission pattern is associated with a first DL-UL frame structure and the second reference signal transmission pattern is associated with a second DL-UL frame structure.

In a tenth aspect, alone or in combination with one or more of the first through ninth aspects, monitoring the one or more reference signal candidate locations includes monitoring a first set of reference signal candidate locations based at least in part on a first reference signal transmission pattern associated with an anchor carrier, or monitoring a second set of reference signal candidate locations based at least in part on a second reference signal transmission pattern associated with a non-anchor carrier.

In an eleventh aspect, alone or in combination with one or more of the first through tenth aspects, process 900 includes obtaining an indication of an additional signal configuration associated with at least one of an NPSS, an NSSS, or an NPBCH associated with the TDD mode of operation.

In a twelfth aspect, alone or in combination with one or more of the first through eleventh aspects, process 900 includes receiving a SIB, wherein the additional signal configuration indicates a first additional signal configuration associated with at least one of the NPSS, the NSSS, or the NPBCH, and a second frame structure and a second additional signal configuration associated with at least one of the NPSS, the NSSS, or the NPBCH, and a second frame structure, monitoring, prior to decoding the SIB, at least one of the NPSS, the NSSS, or the NPBCH based at least in part on the first additional signal configuration, and monitoring, after decoding the SIB, at least one of the NPSS, the NSSS, or the NPBCH based at least in part on the second additional signal configuration.

In a thirteenth aspect, alone or in combination with one or more of the first through twelfth aspects, the first additional signal configuration is associated with a first downlink-uplink frame structure and the second additional signal configuration is associated with a second downlink-uplink frame structure.

In a fourteenth aspect, alone or in combination with one or more of the first through thirteenth aspects, process 900 includes obtaining an indication of an antenna configuration that indicates that the TDD mode of operation is associated with a single-antenna transmission mode.

In a fifteenth aspect, alone or in combination with one or more of the first through fourteenth aspects, the antenna configuration indicates that a reference signal associated with the at least one reference signal transmission pattern and a narrowband synchronization signal are transmitted from the same antenna port.

In a sixteenth aspect, alone or in combination with one or more of the first through fifteenth aspects, the indication is included in a master information block.

In a seventeenth aspect, alone or in combination with one or more of the first through sixteenth aspects, the antenna configuration is associated with one or more frequency bands associated with the TDD mode of operation.

In an eighteenth aspect, alone or in combination with one or more of the first through seventeenth aspects, the TDD mode of operation is associated with a larger quantity of reference signal candidate locations than a default mode of operation.

In a nineteenth aspect, alone or in combination with one or more of the first through eighteenth aspects, the antenna configuration is associated with a DL mode using a single transmit chain.

Although FIG. 9 shows example blocks of process 900, in some aspects, process 900 may include additional blocks, fewer blocks, different blocks, or differently arranged blocks than those depicted in FIG. 9. Additionally, or alternatively, two or more of the blocks of process 900 may be performed in parallel.

FIG. 10 is a diagram illustrating an example process 1000 performed, for example, at a network node or an apparatus of a network node, in accordance with the present disclosure. Example process 1000 is an example where the apparatus or the network node (e.g., network node 110) performs operations associated with availability of signals in a TDD mode of operation.

As shown in FIG. 10, in some aspects, process 1000 may include obtaining an indication of a reference signal configuration associated with a TDD mode of operation, wherein the reference signal configuration indicates at least one reference signal transmission pattern (block 1010). For example, the network node (e.g., using reception component 1202 and/or communication manager 1206, depicted in FIG. 12) may obtain an indication of a reference signal configuration associated with a TDD mode of operation, wherein the reference signal configuration indicates at least one reference signal transmission pattern, as described above.

As further shown in FIG. 10, in some aspects, process 1000 may include transmitting at least one reference signal according to the at least one reference signal transmission pattern (block 1020). For example, the network node (e.g., using transmission component 1204 and/or communication manager 1206, depicted in FIG. 12) may transmit at least one reference signal according to the at least one reference signal transmission pattern, as described above.

Process 1000 may include additional aspects, such as any single aspect or any combination of aspects described below and/or in connection with one or more other processes described elsewhere herein.

In a first aspect, the TDD mode of operation is associated with NB IoT NTN operation.

In a second aspect, alone or in combination with the first aspect, the TDD mode of operation is associated with an NB IoT DL subframe structure that is indicated by a DL subframe bitmap, where all DL subframes, associated with the TDD mode of operation, are NB-IoT DL subframes.

In a third aspect, alone or in combination with one or more of the first and second aspects, the TDD mode of operation is associated with one or more frequency bands.

In a fourth aspect, alone or in combination with one or more of the first through third aspects, the TDD mode of operation is associated with a DL-UL frame structure.

In a fifth aspect, alone or in combination with one or more of the first through fourth aspects, process 1000 includes transmitting a SIB, wherein the at least one reference signal transmission pattern includes a first reference signal transmission pattern associated with monitoring a first set of reference signal candidate locations prior to decoding the SIB and a second reference signal transmission pattern associated with monitoring a second set of reference signal candidate locations after decoding the SIB.

In a sixth aspect, alone or in combination with one or more of the first through fifth aspects, the SIB includes a DL subframe bitmap indicating that the TDD mode of operation is associated with an NB-IoT DL subframe structure, and where all DL subframes, associated with the TDD mode of operation, are NB-IoT DL subframes.

In a seventh aspect, alone or in combination with one or more of the first through sixth aspects, the first reference signal transmission pattern is associated with a first DL-UL frame structure and the second reference signal transmission pattern is associated with a second DL-UL frame structure.

In an eighth aspect, alone or in combination with one or more of the first through seventh aspects, the reference signal configuration includes a first reference signal transmission pattern associated with an anchor carrier and a second reference signal transmission pattern associated with a non-anchor carrier.

In a ninth aspect, alone or in combination with one or more of the first through eighth aspects, process 1000 includes obtaining an indication of an additional signal configuration associated with at least one of an NPSS, an NSSS, or an NPBCH associated with the TDD mode of operation.

In a tenth aspect, alone or in combination with one or more of the first through ninth aspects, process 1000 includes transmitting a SIB, wherein the additional signal configuration indicates a first additional signal configuration associated with at least one of the NPSS, the NSSS, or the NPBCH, and associated with monitoring at least one of the NPSS, the NSSS, or the NPBCH based on the first signal configuration prior to decoding the SIB, and a second additional signal configuration associated with at least one of the NPSS, the NSSS, or the NPBCH and associated with monitoring at least one of the NPSS, the NSSS, or the NPBCH based on the second signal configuration after decoding the SIB.

In an eleventh aspect, alone or in combination with one or more of the first through tenth aspects, the first additional signal configuration is associated with a first downlink-uplink frame structure and the second additional signal configuration is associated with a second downlink-uplink frame structure.

In a twelfth aspect, alone or in combination with one or more of the first through eleventh aspects, process 1000 includes obtaining an indication of an antenna configuration that indicates the TDD mode of operation is associated with a single-antenna transmission mode.

In a thirteenth aspect, alone or in combination with one or more of the first through twelfth aspects, the antenna configuration indicates that a reference signal associated with the at least one reference signal transmission pattern and a narrowband synchronization signal are transmitted from the same antenna port.

In a fourteenth aspect, alone or in combination with one or more of the first through thirteenth aspects, the indication is included in a master information block.

In a fifteenth aspect, alone or in combination with one or more of the first through fourteenth aspects, the antenna configuration is associated with one or more frequency bands associated with the TDD mode of operation.

In a sixteenth aspect, alone or in combination with one or more of the first through fifteenth aspects, the antenna configuration is associated with a DL mode using a single transmit chain.

In a seventeenth aspect, alone or in combination with one or more of the first through sixteenth aspects, the TDD mode of operation is associated with a larger quantity of reference signal candidate locations than a default mode of operation.

Although FIG. 10 shows example blocks of process 1000, in some aspects, process 1000 may include additional blocks, fewer blocks, different blocks, or differently arranged blocks than those depicted in FIG. 10. Additionally, or alternatively, two or more of the blocks of process 1000 may be performed in parallel.

FIG. 11 is a diagram of an example apparatus 1100 for wireless communication, in accordance with the present disclosure. The apparatus 1100 may be a UE, or a UE may include the apparatus 1100. In some aspects, the apparatus 1100 includes a reception component 1102, a transmission component 1104, and/or a communication manager 1106, which may be in communication with one another (for example, via one or more buses and/or one or more other components). In some aspects, the communication manager 1106 is the communication manager 150 described in connection with FIG. 1. As shown, the apparatus 1100 may communicate with another apparatus 1108, such as a UE or a network node (such as a CU, a DU, an RU, or a base station), using the reception component 1102 and the transmission component 1104. The communication manager 1106 may be included in, or implemented via, a processing system (for example, the processing system 140 described in connection with FIG. 1) of the UE.

In some aspects, the apparatus 1100 may be configured to perform one or more operations described herein in connection with FIGS. 8A, 8B, and 8C. Additionally, or alternatively, the apparatus 1100 may be configured to perform one or more processes described herein, such as process 900 of FIG. 9. In some aspects, the apparatus 1100 and/or one or more components shown in FIG. 11 may include one or more components of the UE described in connection with FIG. 1. Additionally, or alternatively, one or more components shown in FIG. 11 may be implemented within one or more components described in connection with FIG. 1. Additionally, or alternatively, one or more components of the set of components may be implemented at least in part as software stored in one or more memories. For example, a component (or a portion of a component) may be implemented as instructions or code stored in a non-transitory computer-readable medium and executable by one or more controllers or one or more processors to perform the functions or operations of the component.

The reception component 1102 may receive communications, such as reference signals, control information, data communications, or a combination thereof, from the apparatus 1108. The reception component 1102 may provide received communications to one or more other components of the apparatus 1100. In some aspects, the reception component 1102 may perform signal processing on the received communications, and may provide the processed signals to the one or more other components of the apparatus 1100. In some aspects, the reception component 1102 may include one or more components of the UE described above in connection with FIG. 1, such as a radio, one or more RF chains, one or more transceivers, or one or more modems, each of which may in turn be coupled with one or more antennas of the UE.

The transmission component 1104 may transmit communications, such as reference signals, control information, data communications, or a combination thereof, to the apparatus 1108. In some aspects, one or more other components of the apparatus 1100 may generate communications and may provide the generated communications to the transmission component 1104 for transmission to the apparatus 1108. In some aspects, the transmission component 1104 may perform signal processing on the generated communications, and may transmit the processed signals to the apparatus 1108. In some aspects, the transmission component 1104 may include one or more components of the UE described above in connection with FIG. 1, such as a radio, one or more RF chains, one or more transceivers, or one or more modems, each of which may in turn be coupled with one or more antennas of the UE described in connection with FIG. 1. In some aspects, the transmission component 1104 may be co-located with the reception component 1102.

The communication manager 1106 may support operations of the reception component 1102 and/or the transmission component 1104. For example, the communication manager 1106 may receive information associated with configuring reception of communications by the reception component 1102 and/or transmission of communications by the transmission component 1104. Additionally, or alternatively, the communication manager 1106 may generate and/or provide control information to the reception component 1102 and/or the transmission component 1104 to control reception and/or transmission of communications.

The reception component 1102 may obtain an indication of a reference signal configuration associated with a TDD mode of operation, wherein the reference signal configuration indicates at least one reference signal transmission pattern. The communication manager 1106 may monitor one or more reference signal candidate locations based at least in part on the at least one reference signal transmission pattern.

The communication manager 1106 may obtain an indication of an additional signal configuration associated with at least one of an NPSS, an NSSS, or an NPBCH associated with the TDD mode of operation.

The reception component 1102 may receive a SIB, wherein the additional signal configuration indicates a first additional signal configuration associated with at least one of the NPSS, the NSSS, or the NPBCH, and a second additional signal configuration associated with at least one of the NPSS, the NSSS, or the NPBCH.

The communication manager 1106 may monitor, prior to decoding the SIB, at least one of the NPSS, the NSSS, or the NPBCH based at least in part on the first additional signal configuration.

The communication manager 1106 may monitor, after decoding the SIB, at least one of the NPSS, the NSSS, or the NPBCH based at least in part on the second additional signal configuration.

The reception component 1102 may obtain an indication of an antenna configuration that indicates that the TDD mode of operation is associated with a single-antenna transmission mode.

The number and arrangement of components shown in FIG. 11 are provided as an example. In practice, there may be additional components, fewer components, different components, or differently arranged components than those shown in FIG. 11. Furthermore, two or more components shown in FIG. 11 may be implemented within a single component, or a single component shown in FIG. 11 may be implemented as multiple, distributed components. Additionally, or alternatively, a set of (one or more) components shown in FIG. 11 may perform one or more functions described as being performed by another set of components shown in FIG. 11.

FIG. 12 is a diagram of an example apparatus 1200 for wireless communication, in accordance with the present disclosure. The apparatus 1200 may be a network node, or a network node may include the apparatus 1200. In some aspects, the apparatus 1200 includes a reception component 1202, a transmission component 1204, and/or a communication manager 1206, which may be in communication with one another (for example, via one or more buses and/or one or more other components). In some aspects, the communication manager 1206 is the communication manager 155 described in connection with FIG. 1. As shown, the apparatus 1200 may communicate with another apparatus 1208, such as a UE or a network node (such as a CU, a DU, an RU, or a base station), using the reception component 1202 and the transmission component 1204. The communication manager 1206 may be included in, or implemented via, a processing system (for example, the processing system 145 described in connection with FIG. 1) of the network node.

In some aspects, the apparatus 1200 may be configured to perform one or more operations described herein in connection with FIGS. 8A, 8B, and 8C. Additionally, or alternatively, the apparatus 1200 may be configured to perform one or more processes described herein, such as process 1000 of FIG. 10. In some aspects, the apparatus 1200 and/or one or more components shown in FIG. 12 may include one or more components of the network node described in connection with FIG. 1. Additionally, or alternatively, one or more components shown in FIG. 12 may be implemented within one or more components described in connection with FIG. 1. Additionally, or alternatively, one or more components of the set of components may be implemented at least in part as software stored in one or more memories. For example, a component (or a portion of a component) may be implemented as instructions or code stored in a non-transitory computer-readable medium and executable by one or more controllers or one or more processors to perform the functions or operations of the component.

The reception component 1202 may receive communications, such as reference signals, control information, data communications, or a combination thereof, from the apparatus 1208. The reception component 1202 may provide received communications to one or more other components of the apparatus 1200. In some aspects, the reception component 1202 may perform signal processing on the received communications, and may provide the processed signals to the one or more other components of the apparatus 1200. In some aspects, the reception component 1202 may include one or more components of the network node described above in connection with FIG. 1, such as a radio, one or more RF chains, one or more transceivers, or one or more modems, each of which may in turn be coupled with one or more antennas of the network node. In some aspects, the reception component 1202 and/or the transmission component 1204 may include or may be included in a network interface. The network interface may be configured to obtain and/or output signals for the apparatus 1200 via one or more communications links, such as a backhaul link, a midhaul link, and/or a fronthaul link.

The transmission component 1204 may transmit communications, such as reference signals, control information, data communications, or a combination thereof, to the apparatus 1208. In some aspects, one or more other components of the apparatus 1200 may generate communications and may provide the generated communications to the transmission component 1204 for transmission to the apparatus 1208. In some aspects, the transmission component 1204 may perform signal processing on the generated communications, and may transmit the processed signals to the apparatus 1208. In some aspects, the transmission component 1204 may include one or more components of the network node described above in connection with FIG. 1, such as a radio, one or more RF chains, one or more transceivers, or one or more modems, each of which may in turn be coupled with one or more antennas of the network node described in connection with FIG. 1. In some aspects, the transmission component 1204 may be co-located with the reception component 1202.

The communication manager 1206 may support operations of the reception component 1202 and/or the transmission component 1204. For example, the communication manager 1206 may receive information associated with configuring reception of communications by the reception component 1202 and/or transmission of communications by the transmission component 1204. Additionally, or alternatively, the communication manager 1206 may generate and/or provide control information to the reception component 1202 and/or the transmission component 1204 to control reception and/or transmission of communications.

The reception component 1202 may obtain an indication of a reference signal configuration associated with a TDD mode of operation, wherein the reference signal configuration indicates at least one reference signal transmission pattern. The transmission component 1204 may transmit at least one reference signal according to the at least one reference signal transmission pattern.

The transmission component 1204 may transmit a SIB, wherein the at least one reference signal transmission pattern includes a first reference signal transmission pattern associated with monitoring a first set of reference signal candidate locations prior to decoding the SIB and a second reference signal transmission pattern associated with monitoring a second set of reference signal candidate locations after decoding the SIB.

The communication manager 1206 may obtain an indication of an additional signal configuration associated with at least one of an NPSS, an NSSS, or an NPBCH associated with the TDD mode of operation.

The transmission component 1204 may transmit a SIB, wherein the additional signal configuration indicates a first additional signal configuration associated with at least one of the NPSS, the NSSS, or the NPBCH, and associated with monitoring at least one of the NPSS, the NSSS, or the NPBCH prior to decoding the SIB, and a second additional signal configuration associated with at least one of the NPSS, the NSSS, or the NPBCH and associated with monitoring at least one of the NPSS, the NSSS, or the NPBCH after decoding the SIB.

The reception component 1202 may obtain an indication of an antenna configuration that indicates that the TDD mode of operation is associated with a single-antenna transmission mode.

The number and arrangement of components shown in FIG. 12 are provided as an example. In practice, there may be additional components, fewer components, different components, or differently arranged components than those shown in FIG. 12. Furthermore, two or more components shown in FIG. 12 may be implemented within a single component, or a single component shown in FIG. 12 may be implemented as multiple, distributed components. Additionally, or alternatively, a set of (one or more) components shown in FIG. 12 may perform one or more functions described as being performed by another set of components shown in FIG. 12.

The following provides an overview of some Aspects of the present disclosure:

Aspect 1: A method of wireless communication performed by a user equipment (UE), comprising: obtaining an indication of a reference signal configuration associated with a time division duplex (TDD) mode of operation, wherein the reference signal configuration indicates at least one reference signal transmission pattern; and monitoring one or more reference signal candidate locations based at least in part on the at least one reference signal transmission pattern.

Aspect 2: The method of Aspect 1, wherein the TDD mode of operation is associated with narrowband internet-of-things non-terrestrial network operation.

Aspect 3: The method of any of Aspects 1-2, wherein the TDD mode of operation is associated with a narrowband (NB)-internet-of-things (IoT) downlink subframe structure that is indicated by a downlink subframe bitmap, and wherein all downlink subframes, associated with the TDD mode of operation, are NB-IoT downlink subframes.

Aspect 4: The method of any of Aspects 1-3, wherein the TDD mode of operation is associated with one or more frequency bands.

Aspect 5: The method of any of Aspects 1-4, wherein the TDD mode of operation is associated with a downlink-uplink frame structure.

Aspect 6: The method of any of Aspects 1-5, wherein monitoring the one or more reference signal candidate locations occurs prior to a decoding of a system information block.

Aspect 7: The method of any of Aspects 1-6, wherein monitoring the one or more reference signal candidate locations occurs after a decoding of a system information block.

Aspect 8: The method of any of Aspects 1-7, wherein monitoring the one or more reference signal candidate locations includes: receiving a system information block (SIB), wherein the at least one reference signal transmission pattern includes a first reference signal transmission pattern associated with a first set of reference signal candidate locations and a second reference signal transmission pattern associated with a second set of reference signal candidate locations; monitoring, prior to decoding the SIB, the first set of reference signal candidate locations based at least in part on the first reference signal transmission pattern; and monitoring, after decoding the SIB, the second set of reference signal candidate locations based at least in part on the second reference signal transmission pattern.

Aspect 9: The method of Aspect 8, wherein the SIB includes a DL subframe bitmap indicating that the TDD mode of operation is associated with a narrowband (NB)-Internet of Things (IoT) downlink subframe structure, and where all downlink subframes, associated with the TDD mode of operation, are NB-IoT downlink subframes.

Aspect 10: The method of Aspect 8, wherein the first reference signal transmission pattern is associated with a first downlink-uplink frame structure and the second reference signal transmission pattern is associated with a second downlink-uplink frame structure.

Aspect 11: The method of any of Aspects 1-10, wherein monitoring the one or more reference signal candidate locations includes: monitoring a first set of reference signal candidate locations based at least in part on a first reference signal transmission pattern associated with an anchor carrier; or monitoring a second set of reference signal candidate locations based at least in part on a second reference signal transmission pattern associated with a non-anchor carrier.

Aspect 12: The method of any of Aspects 1-11, further comprising: obtaining an indication of an additional signal configuration associated with at least one of a narrowband primary synchronization signal, a narrowband secondary synchronization signal, or a narrowband physical broadcast channel associated with the TDD mode of operation.

Aspect 13: The method of Aspect 12, further comprising: receiving a system information block (SIB), wherein the additional signal configuration indicates: a first additional signal configuration associated with at least one of a narrowband primary synchronization signal (NPSS), a narrowband secondary synchronization signal (NSSS), or a narrowband physical broadcast channel (NPBCH), and a second additional signal configuration associated with at least one of the NPSS, the NSSS, or the NPBCH, monitoring, prior to decoding the SIB, at least one of the NPSS, the NSSS, or the NPBCH based at least in part on the first additional signal configuration; and monitoring, after decoding the SIB, at least one of the NPSS, the NSSS, or the NPBCH based at least in part on the second additional signal configuration.

Aspect 14: The method of Aspect 13, wherein the first additional signal configuration is associated with a first downlink-uplink frame structure and the second additional signal configuration is associated with a second downlink-uplink frame structure.

Aspect 15: The method of any of Aspects 1-14, further comprising: obtaining an indication of an antenna configuration that indicates that the TDD mode of operation is associated with a single-antenna transmission mode.

Aspect 16: The method of Aspect 15, wherein the antenna configuration is associated with a downlink mode using a single transmit chain.

Aspect 17: The method of Aspect 15, wherein the antenna configuration indicates that a reference signal associated with the at least one reference signal transmission pattern and a narrowband synchronization signal are transmitted from the same antenna port.

Aspect 18: The method of Aspect 15, wherein the indication is included in a master information block.

Aspect 19: The method of Aspect 15, wherein the antenna configuration is associated with one or more frequency bands associated with the TDD mode of operation.

Aspect 20: The method of any of Aspects 1-19, wherein the TDD mode of operation is associated with a larger quantity of reference signal candidate locations than a default mode of operation.

Aspect 21: A method of wireless communication performed by a network node, comprising: obtaining an indication of a reference signal configuration associated with a time division duplex (TDD) mode of operation, wherein the reference signal configuration indicates at least one reference signal transmission pattern; and transmitting at least one reference signal according to the at least one reference signal transmission pattern.

Aspect 22: The method of Aspect 21, wherein the TDD mode of operation is associated with narrowband internet-of-things non-terrestrial network operation.

Aspect 23: The method of any of Aspects 21-22, wherein the TDD mode of operation is associated with a narrowband (NB)-internet-of-things (IoT) downlink subframe structure that is indicated by a downlink subframe bitmap, and wherein all downlink subframes, associated with the TDD mode of operation, are NB-IoT downlink subframes.

Aspect 24: The method of any of Aspects 21-23, wherein the TDD mode of operation is associated with one or more frequency bands.

Aspect 25: The method of any of Aspects 21-24, wherein the TDD mode of operation is associated with a downlink-uplink frame structure.

Aspect 26: The method of any of Aspects 21-25, further comprising: transmitting a system information block (SIB), wherein the at least one reference signal transmission pattern includes a first reference signal transmission pattern associated with monitoring a first set of reference signal candidate locations prior to decoding the SIB and a second reference signal transmission pattern associated with monitoring a second set of reference signal candidate locations after decoding the SIB.

Aspect 27: The method of Aspect 26, wherein the first reference signal transmission pattern is associated with a first downlink-uplink frame structure and the second reference signal transmission pattern is associated with a second downlink-uplink frame structure.

Aspect 28: The method of any of Aspects 21-27, wherein the reference signal configuration includes a first reference signal transmission pattern associated with an anchor carrier and a second reference signal transmission pattern associated with a non-anchor carrier.

Aspect 29: The method of any of Aspects 21-28, further comprising: obtaining an indication of an additional signal configuration associated with at least one of a narrowband primary synchronization signal (NPSS), a narrowband secondary synchronization signal (NSSS), or a narrowband physical broadcast channel (NPBCH) associated with the TDD mode of operation.

Aspect 30: The method of Aspect 29, further comprising: transmitting a system information block (SIB), wherein the additional signal configuration indicates: a first additional signal configuration associated with at least one of the NPSS, the NSSS, or the NPBCH, and associated with monitoring at least one of the NPSS, the NSSS, or the NPBCH based at least in part on the first additional signal configuration prior to decoding the SIB, and a second additional signal configuration associated with at least one of the NPSS, the NSSS, or the NPBCH and associated with monitoring the NPSS, the NSSS, or the NPBCH based at least in part on the second additional signal configuration after decoding the SIB.

Aspect 31: The method of Aspect 30, wherein the first additional signal configuration is associated with a first downlink-uplink frame structure and the second additional signal configuration is associated with a second downlink-uplink frame structure.

Aspect 32: The method of any of Aspects 21-31, further comprising: obtaining an indication of an antenna configuration that indicates that the TDD mode of operation is associated with a single-antenna transmission mode.

Aspect 33: The method of Aspect 32, wherein the antenna configuration is associated with a downlink mode using a single transmit chain.

Aspect 34: The method of Aspect 33, wherein the antenna configuration indicates that a reference signal associated with the at least one reference signal transmission pattern and a narrowband synchronization signal are transmitted from the same antenna port.

Aspect 35: The method of Aspect 33, wherein the indication is included in a master information block.

Aspect 36: The method of Aspect 33, wherein the antenna configuration is associated with one or more frequency bands associated with the TDD mode of operation.

Aspect 37: The method of any of Aspects 21-36, wherein the TDD mode of operation is associated with a larger quantity of reference signal candidate locations than a default mode of operation.

Aspect 38: An apparatus for wireless communication at a device, the apparatus comprising one or more processors; one or more memories coupled with the one or more processors; and instructions stored in the one or more memories and executable by the one or more processors to cause the apparatus to perform the method of one or more of Aspects 1-37.

Aspect 39: An apparatus for wireless communication at a device, the apparatus comprising one or more memories and one or more processors coupled to the one or more memories, the one or more processors configured to cause the device to perform the method of one or more of Aspects 1-37.

Aspect 40: An apparatus for wireless communication, the apparatus comprising at least one means for performing the method of one or more of Aspects 1-37.

Aspect 41: A non-transitory computer-readable medium storing code for wireless communication, the code comprising instructions executable by one or more processors to perform the method of one or more of Aspects 1-37.

Aspect 42: A non-transitory computer-readable medium storing a set of instructions for wireless communication, the set of instructions comprising one or more instructions that, when executed by one or more processors of a device, cause the device to perform the method of one or more of Aspects 1-37.

Aspect 43: A device for wireless communication, the device comprising a processing system that includes one or more processors and one or more memories coupled with the one or more processors, the processing system configured to cause the device to perform the method of one or more of Aspects 1-37.

Aspect 44: An apparatus for wireless communication at a device, the apparatus comprising one or more memories and one or more processors coupled to the one or more memories, the one or more processors individually or collectively configured to cause the device to perform the method of one or more of Aspects 1-37.

The foregoing disclosure provides illustration and description but is not intended to be exhaustive or to limit the aspects to the precise forms disclosed. Modifications and variations may be made in light of the above disclosure or may be acquired from practice of the aspects. No element, act, or instruction described herein should be construed as critical or essential unless explicitly described as such.

It will be apparent that systems or methods described herein may be implemented in different forms of hardware or a combination of hardware and software. The actual specialized control hardware or software used to implement these systems or methods is not limiting of the aspects. Thus, the operation and behavior of the systems or methods are described herein without reference to specific software code, because those skilled in the art will understand that software and hardware can be designed to implement the systems or methods based, at least in part, on the description herein. A component being configured to perform a function means that the component has a capability to perform the function, and does not require the function to be actually performed by the component, unless noted otherwise.

As used herein, the articles “a” and “an” are intended to refer to one or more items and may be used interchangeably with “one or more” or “at least one.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or “a single one” or similar language is used. Also, as used herein, the terms “has,” “have,” “having,” “comprise,” “comprising,” “include” and “including,” and derivatives thereof or similar terms are intended to be open-ended terms that do not limit an element that they modify (for example, an element “having” A may also have B). Also, as used herein, the term “or” is intended to be inclusive when used in a series and may be used interchangeably with “and/or,” unless explicitly stated otherwise (for example, if used in combination with “either” or “only one of”). As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (for example, a+a, a+a+a, a+a+b, a+a+c, a+b+b, a+c+c, b+b, b+b+b, b+b+c, c+c, and c+c+c, or any other ordering of a, b, and c).

As used herein, the term “determine” or “determining” encompasses a wide variety of actions and, therefore, “determining” can include calculating, computing, processing, deriving, estimating, investigating, looking up (such as via looking up in a table, a database, or another data structure), searching, inferring, ascertaining, and/or measuring, among other possibilities. Also, “determining” can include receiving (such as receiving information), accessing (such as accessing data stored in memory) or transmitting (such as transmitting information), among other possibilities. Additionally, “determining” can include resolving, selecting, obtaining, choosing, establishing, and/or other such similar actions.

As used herein, the phrase “based on” is intended to mean “based at least in part on” or “based on or otherwise in association with” unless explicitly stated otherwise. As used herein, “satisfying a threshold” may, depending on the context, refer to a value being greater than the threshold, greater than or equal to the threshold, less than the threshold, less than or equal to the threshold, equal to the threshold, or not equal to the threshold, among other examples.

Even though particular combinations of features are recited in the claims or disclosed in the specification, these combinations are not intended to limit the scope of all aspects described herein. Many of these features may be combined in ways not specifically recited in the claims or disclosed in the specification. The disclosure of various aspects includes each dependent claim in combination with every other claim in the claim set.

What is claimed is:

1. An apparatus for wireless communication at a user equipment (UE), comprising:
one or more memories; and
one or more processors, coupled to the one or more memories, which individually or in any combination, are operable to cause the apparatus to:
obtain an indication of a reference signal configuration associated with a time division duplex (TDD) mode of operation, wherein the reference signal configuration indicates at least one reference signal transmission pattern; and
monitor one or more reference signal candidate locations based at least in part on the at least one reference signal transmission pattern.

2. The apparatus of claim 1, wherein the TDD mode of operation is associated with narrowband internet-of-things non-terrestrial network operation.

3. The apparatus of claim 1, wherein the TDD mode of operation is associated with a narrowband (NB)-internet-of-things (IoT) downlink subframe structure that is indicated by a downlink subframe bitmap, and
wherein all downlink subframes, associated with the TDD mode of operation, are NB-IoT downlink subframes.

4. The apparatus of claim 1, wherein the TDD mode of operation is associated with one or more frequency bands.

5. The apparatus of claim 1, wherein the TDD mode is associated with a downlink-uplink frame structure.

6. The apparatus of claim 1, wherein the one or more processors, to cause the UE to monitor the one or more reference signal candidate locations, are configured to cause the apparatus to:
receive a system information block (SIB), wherein the at least one reference signal transmission pattern includes a first reference signal transmission pattern associated with a first set of reference signal candidate locations and a second reference signal transmission pattern associated with a second set of reference signal candidate locations;
monitor, prior to decoding the SIB, the first set of reference signal candidate locations based at least in part on the first reference signal transmission pattern; and
monitor, after decoding the SIB, the second set of reference signal candidate locations based at least in part on the second reference signal transmission pattern.

7. The apparatus of claim 6, wherein the SIB includes a downlink subframe bitmap indicating that the TDD mode of operation is associated with a narrowband (NB)-internet-of-things (IoT) downlink subframe structure, and
wherein all downlink subframes, associated with the TDD mode of operation, are NB-IoT downlink subframes.

8. The apparatus of claim 1, wherein the one or more processors, to cause the apparatus to monitor the one or more reference signal candidate locations, are configured to cause the apparatus to:
monitor a first set of reference signal candidate locations based at least in part on a first reference signal transmission pattern associated with an anchor carrier; or
monitor a second set of reference signal candidate locations based at least in part on a second reference signal transmission pattern associated with a non-anchor carrier.

9. The apparatus of claim 1, wherein the one or more processors are further configured to cause the apparatus to:
obtain an indication of an additional signal configuration associated with at least one of a narrowband primary synchronization signal (NPSS), a narrowband secondary synchronization signal (NSSS), or a narrowband physical broadcast channel (NPBCH) associated with the TDD mode of operation.

10. The apparatus of claim 9, wherein the one or more processors are further configured to cause the apparatus to:
receive a system information block (SIB), wherein the additional signal configuration indicates:
a first additional signal configuration associated with at least one of the NPSS, the NSSS, or the NPBCH, and
a second additional signal configuration associated with at least one of the NPSS, NSSS, or the NPBCH,
monitor, prior to decoding the SIB, at least one of the NPSS, the NSSS, or the NPBCH based at least in part on the first additional signal configuration; and
monitor, after decoding the SIB, at least one of the NPSS, the NSSS, or the NPBCH based at least in part on the second additional signal configuration.

11. The apparatus of claim 10, wherein the first additional signal configuration is associated with a first downlink-uplink frame structure and the second additional signal configuration is associated with a second downlink-uplink frame structure.

12. The apparatus of claim 1, wherein the one or more processors are further configured to cause the apparatus to:
obtain an indication of an antenna configuration that indicates that the TDD mode of operation is associated with a single-antenna transmission mode.

13. The apparatus of claim 12, wherein the antenna configuration indicates that a reference signal associated with the at least one reference signal transmission pattern and a narrowband synchronization signal are transmitted from the same antenna port.

14. The apparatus of claim 12, wherein the indication is included in a master information block.

15. The apparatus of claim 1, wherein the TDD mode of operation is associated with a larger quantity of reference signal candidate locations than a default mode of operation.

16. An apparatus for wireless communication at a network node, comprising:
one or more memories; and
one or more processors, coupled to the one or more memories, which, individually or in any combination, are operable to cause the apparatus to:
obtain an indication of a reference signal configuration associated with a time division duplex (TDD) mode of operation, wherein the reference signal configuration indicates at least one reference signal transmission pattern; and
transmit at least one reference signal according to the at least one reference signal transmission pattern.

17. The apparatus of claim 16, wherein the TDD mode of operation is associated with narrowband internet-of-things non-terrestrial network operation.

18. The apparatus of claim 16, wherein the one or more processors, to cause the UE to monitor the one or more reference signal candidate locations, are configured to cause the apparatus to:
receive a system information block (SIB), wherein the at least one reference signal transmission pattern includes a first reference signal transmission pattern associated with a first set of reference signal candidate locations and a second reference signal transmission pattern associated with a second set of reference signal candidate locations;
monitor, prior to decoding the SIB, the first set of reference signal candidate locations based at least in part on the first reference signal transmission pattern; and
monitor, after decoding the SIB, the second set of reference signal candidate locations based at least in part on the second reference signal transmission pattern,
wherein the SIB includes a downlink subframe bitmap indicating that the TDD mode of operation is associated with a narrowband (NB)-internet-of-things (IoT) downlink subframe structure, and
wherein all downlink subframes, associated with the TDD mode of operation, are NB-IoT downlink subframes.

19. The apparatus of claim 16, wherein the TDD mode of operation is associated with a narrowband (NB)-internet-of-things (IOT) downlink subframe structure that is indicated by a downlink subframe bitmap, and
wherein all downlink subframes, associated with the TDD mode of operation, are NB-IoT downlink subframes.

20. A method of wireless communication performed by a user equipment (UE), comprising:
obtaining an indication of a reference signal configuration associated with a time division duplex (TDD) mode of operation, wherein the reference signal configuration indicates at least one reference signal transmission pattern; and
monitoring one or more reference signal candidate locations based at least in part on the at least one reference signal transmission pattern.
